(19) United States
(12) Patent Application Publication
(10) Pub. No.: US 2018/0268015 A1
(43) Pub. Date: Sep. 20, 2018

(54) METHOD AND APPARATUS FOR LOCATING ERRORS IN DOCUMENTS VIA DATABASE QUERIES, SIMILARITY-BASED INFORMATION RETRIEVAL AND MODELING THE ERRORS FOR ERROR RESOLUTION

(71) Applicant: Sasha Sugaberry, Redmond, WA (US)

(72) Inventor: Sasha Sugaberry, Redmond, WA (US)

(21) Appl. No.: 15/254,214

(22) Filed: Sep. 1, 2016

Related U.S. Application Data
(60) Provisional application No. 62/213,428, filed on Sep. 2, 2015.

(51) Int. Cl. G06F 17/30; G06Q 30/00; G06Q 40/00; G06Q 10/06; G06N 3/04; G06N 3/063

(52) U.S. Cl. CPC G06F 17/30371; G06F 17/30011; G06F 17/30528; G06N 3/063; G06Q 40/123; G06Q 10/067; G06N 3/04; G06Q 30/0185

(57) ABSTRACT

Method and apparatus for recognizing errors in documents which may comprise text and images and resolving recognized errors automatically comprise application of a search manager for analyzing parameters of a plurality of databases for a plurality of objects, the databases comprising a product database, a product provider database, a service database, a service provider database and an image database whereby the databases store data objects containing identifying features, source information and document properties and context including time and frequency varying data. Data acquisition and communication devices may comprise near field communication and camera devices for collecting document data. The method comprises application of multivariate statistical analysis and principal component analysis in combination with content-based image retrieval for providing two-dimensional attributes of three dimensional objects, for example, via preferential image segmentation using a tree of shapes to recognize document errors such as tax application errors and to resolve errors/issues by means of k-means clustering and related methods via a client/cloud-based server system. By way of example, an example of an erroneous application of sales tax to clothing/food which may/may not be taxed in a given jurisdiction (Delaware, Pa.) may be recognized and resolved by client/server/database query and issue escalation.

This application claims the benefit of priority to U.S. Provisional Patent Application Ser. No. 62/213,428, filed Sep. 2, 2015 by Sasha Sugaberry, and incorporates it by reference in its entirety.

### TECHNICAL FIELD

The technical field relates to a method and apparatus for locating errors in documents via database queries, similarity-based information retrieval and modeling to resolve the errors and, in particular, to the application of database and modeling software supporting model-based inference of erroneous data recorded in at least one of a plurality of databases of information including a resolution of the issue which may relate to, for example, fraud.

### BACKGROUND AND RELATED ARTS

Database systems and search and retrieval from such databases are known. For example, U.S. Pat. No. 5,911,139 to Jain et al. describes a visual image database search engine which allows for different schema. A schema is a specific collection of primitives to be processed and a corresponding feature vector is used for similarity scoring. In particular, a system and method for content-based search and retrieval of visual objects computes a distance between two feature vectors in a comparison process to generate a similarity score.

U.S. Pat. No. 6,778,995 to Gallivan describes a system and method for efficiently generating cluster groupings in a multi-dimensional concept space. A plurality of terms is extracted from documents of a collection of stored, unstructured documents. A concept space is built over the collection and terms correlated between documents such that a vector may be mapped for each correlated term. Referring to FIG. 14 of the '995 patent, a cluster is populated with documents having vector differences falling within a predetermined variance such that a view may be generated of overlapping clusters. As used in this patent application, the term “document” should be considered in its broadest sense in physical or electronic form and not be limited to a paper document such as an invoice.

U.S. Pat. No. 7,236,971 to Shatdal et al. describes a method and system for deriving data through interpolation in a database system. A parallel database system has plural processing units capable of performing interpolation of data in parallel.

U.S. Pat. No. 7,318,053 to Cha et al. describes an indexing system and method for nearest neighbor searches in high dimensional databases using vectors representing objects in n-dimensional space and local polar coordinates for vectors such that a query data vector is requested to find “k” nearest neighbors to the query vector of the vectors in the n-dimensional space.

U.S. Pat. No. 8,375,032 issued Feb. 12, 2013; U.S. Pat. No. 8,392,418 issued Mar. 5, 2013; and U.S. Pat. No. 8,396,870 issued Mar. 12, 2013 to J. Douglas Birdwell et al. comprise a series of patents directed to prediction of object properties and events using similarity-based information retrieval and modeling where the database comprise spectral, image and microbody databases. While these patents bear little relationship to locating documentation errors, the principles taught of content-based image recognition, multivariate statistical analysis and the like may be applied to other databases and models developed for solving other problems.

More recently, U.S. Published Patent Application No.'s 2015/0106306; 2015/0106310; 2015/0106311; 2015/0106314 and 2015/0106316 published Apr. 16, 2015 of J. Douglas Birdwell et al. describe either artificial neural networks simulated as special purpose neuroscience-inspired dynamic artificial networks (NIDA) on known computer processing systems or built as dynamic artificial neural network arrays (DANNA) of neurons and synapses have been used for resolution of problems such as anomaly detection, problem solving, modeling and classification over time. Such artificial neural networks promise a future of real time anomaly detection, classification, modeling and resolution in, for example, a documentation error discovery and resolution process environment.

Over the years, fuzzy logic, artificial intelligence, neural networks, data mining, linkage analysis, geographic and time of incident graphical analysis and even Bayesian networks have been used to identify patterns in different types of documented errors which may amount to a fraud on the consumer of products and services involving unintentional and intentional deception by the offending product or service provider. An example might be the inappropriate calculation of sales and use taxes on a product or service variant with the tax jurisdiction, state and local, or the application of state and local income tax deductions from a pay check or the calculation of real or personal property taxes on a tax bill. A charge for a product or service may be exceptionally identified as high with respect to a norm, for example. While these errors may be identified by a human, an artificial intelligence system coupled with a special purpose computer processor may be demonstrated to obtain a faster, automatic and programmed response without human intervention.

Near field communication (NFC) is a set of ideas and technology that enables smartphones and other devices to establish radio communication with each other by touching the devices together or bringing them into proximity to a distance of typically 10 cm (3.9 in) or less. What distinguishes NFC is that devices are often cloud connected meaning they may communicate with cloud provided services. NFC-enabled smartphones may be provided with dedicated software applications including ‘ticket’ readers as opposed to the traditional dedicated infrastructure that specifies a particular (often proprietary) standard for stock ticket, access control and payment readers. By contrast all NFC peers can connect to a third party NFC device that acts as a server for any action (or reconfiguration).

Like existing ‘proximity card’ technologies, NFC employs electromagnetic induction between two loop antennae when NFC devices—for example, a ‘smart phone’ and a ‘smart poster’—may exchange information, operating within the globally available unlicensed radio frequency ISM band of 13.56 MHz on ISO/IEC 18000-3 air interface and at rates ranging from 106 kbit/s to 424 kbit/s.

Each full NFC device can work in three modes: NFC Card Emulation; NFC Reader/Writer; and NFC peer-to-peer (P2P mode): 1) NFC Card emulation mode enables NFC-enabled devices such as smartphones to act like smart cards, allowing users to perform transactions such as payment or ticketing; 2) NFC Reader/writer mode enables NFC-enabled devices to read information stored on inexpensive NFC tags embedded in labels or smart posters; and 3) NFC peer-to-peer mode enables two NFC-enabled devices to communicate with each other to exchange information.

NFC tags typically contain data (currently between 96 and 4,096 bytes of memory) and are read-only, but may be rewritable. Applications include secure personal data storage (e.g. debit or credit card information, loyalty program data, Personal Identification Numbers (PINs), contacts). NFC tags can be custom-encoded by their manufacturers or use the industry specifications provided by the NFC Forum, an association with more than 160 members founded in 2004 by Nokia. Philips Semiconductors (which became NXP Semiconductors in 2006) and Sony were charged with promoting the technology and setting key standards, which includes the definition of four distinct types of tags that provide different communication speeds and capabilities in terms of flexibility, memory, security, data retention and write endurance. The NFC Forum also promotes NFC and certifies device compliance and whether a given device fits the criteria for being considered a personal area network.

NFC standards cover communications protocols and data exchange formats and are based on existing radio-frequency identification (RFID) standards including ISO/IEC 14443 and FeliCa. The standards include ISO/IEC 18092 and those defined by the NFC Forum. In addition to the NFC Forum, the GSMA has also worked to define a platform for the deployment of “GSMA NFC Standards”. Within mobile handsets. GSMA's efforts include Trusted Services Manager, Single Wire Protocol, testing and certification and secure element.

A patent licensing program for NFC is currently under deployment by France Brevets, a patent fund created in 2011. This program was under development by Via Licensing Corporation, an independent subsidiary of Dolby Laboratories. This program may have terminated in May 2012. A public, platform-independent NFC library is released under the free GNU Lesser General Public License by the name libnfc. Present and anticipated applications include contactless transactions, data exchange, and simplified setup of more complex communications such as Wi-Fi.

For example, coupons and customer reward points may be pre-loaded on the user's smartphone and may be applied to the total automatically when the user purchases items at a store via an NFC transaction terminal. Payment occurs when a user waves an NFC smartphone over the card reader.

Active NFC devices (for example, Apple Pay and Google Wallet) may read information and send it. An active NFC device, like a smartphone, may not only be able to collect information from NFC tags, but may also be able to exchange information with other compatible NFC phones or devices such as NFC transaction terminals and personal computers and even alter the information on the NFC tag if authorized to make such changes.

To ensure security, NFC often establishes a secure channel and uses encryption when sending sensitive information such as credit card numbers. Users may further protect their private data by keeping anti-virus software on their NFC smartphones and by adding a password to the phone so a thief cannot use it in the event that the smartphone is lost or stolen. Users may load multiple credit or debit cards and choose which one they wish to use for each transaction.

Other systems and database technologies are known which incorporate multivariate statistical analysis and, in particular, principal component analysis, from patent and non-patent literature and other technologies to locate clusters of anomalies, analyze the anomalies and attempt resolution of the anomalies automatically through a special purpose computer client system capable of database querying and internet communication with product and service providers. However, there remains a need in the art for improved methods and apparatus for locating errors in documents, for example, associated with transactions through database querying and similarity-based processing and to resolve the errors through modeling and interactive communication with a provider of goods or services to resolve the discovered error or locate alternative providers of goods and services in the event resolution fails and a competitor provides equivalent or better products and services.

### SUMMARY OF THE PREFERRED EMBODIMENTS

In accordance with an embodiment of a method and apparatus for locating object properties, in particular error clusters in documents using similarity-based information retrieval and modeling and an aspect thereof, database and modeling technologies can infer properties such as, for example, fraudulent product, erroneous product and service pricing, sales tax errors, labor pricing errors and other errors in documents by collecting similar data objects and properties from competitors about the world from similar previously analyzed objects of competitors collected about the world and having their properties stored in a local special purpose server database or in the cloud for comparison with those collected from the product or service related documentation at a local client. Measurable properties of the objects such as quality and price may be stored in one or a plurality of databases including multi-dimensional databases at client or server. While exact matches to reference data may not be expected in response to a query for a similar object given a target object under investigation, an automated search strategy may locate nearest neighbor items, or items within a specified neighborhood, with the most similar properties, from a reference collection and utilize any product or service competitor or other information associated with these items to predict properties and features erroneously presented in an input document or tag and more reasonably available from the product or service provider or their competitor. Models are then utilized to predict properties of the objects from the similar data. The term “object” is intended to incorporate micro to macro size objects as well as text, data, tag and image objects thereof which may have three dimensional shape and size properties that may include any of the following: material composition, texture, shape, color, time or frequency varying data, image data, model and serial number, SKU number, product or service provider data, location of manufacture and the like. Correlations may be with features, such as proximity to a the user of the product or service provider, identity of manufacturer or builder or service provider, object identification or signature characteristics (for example, related to uniqueness such as art authentication), product identification or service characteristics such as quality of labor (union or non-union) and the like, so an estimate may be desired of the physical or ethnic source or origin or the likely characteristics of the source or origin of a target object.

A plurality of databases and a modeling and search capability extends and exploits already patented similarity-based indexing and search technologies developed at the University of Tennessee. The following patents and published applications as well as those identified above in the Background section are incorporated by reference as to their entire contents: U.S. Pat. Nos. 6,741,983; 7,272,612; 7,454,41; 8,099,733 issued Jan. 17, 2012; U.S. Pat. No. 7,8822,106 issued Feb. 1, 2011; U.S. Pat. No. 7,769,893 issued Aug. 3, 2010 and U.S. Pat. No. 8,060,522 issued Nov. 15, 2011 directed to a parallel data processing system and a method of indexed storage and retrieval of multidimensional information and organizing data records into clusters or groups of objects. For example, these applications and patents may describe by way of example, the clustering of products and services and their composition such as those resulting from a product or service provider and their competitors to predict object similar object properties. A database populated with measured properties of sample objects, not limited to, but, by way of example, material, tax or labor measurements (such as quality of material or cost and quality of labor), may point to the source of the sample objects or sources of competitor products and services. Their characteristic properties can be indexed and searched using these technologies to enable the rapid retrieval of information most relevant to an object as broadly defined to determine errors or potential errors in the provision of products and services. The indexing methodology relies upon data reduction methods such as principal component analysis, together with data clustering algorithms, to rapidly isolate potential matches to predict properties of the object, thus producing a selection of reference data that best match the measured properties for the object.

Objects such as documents and information collected from the same or competitor product or service provider that have been previously collected are analyzed and characterized using, for example, content-based image recognition and text parsing and sampling to obtain cognitive intelligence about the product or service under investigation and other objective and subjective information about an exemplary object such as price and perceived quality. Data coding methods for a plurality of multi-dimensional databases that are compatible with the present similarity-based indexing and search methodology support an analysis and exploitation of the correlations between product or service data and location/feature and other property prediction data in order to determine erroneous data and a likelihood that the data is erroneous and injurious and, moreover, predict the consequences of the located erroneous data. Databases and related modeling software may utilize the proposed methodology including, for example, a plurality of databases comprising product and service data provided by a manufacturer or by a product or service provider under investigation from the literature (catalogs, the internet or world wide web) and content based image recognition (CBIR) databases maintained for objects of interest as will be discussed herein.

Modeling software and related database technology may lead to an inference of an error or issue to be resolved, for example, during or after a product or service transaction is attempted and characteristics of related data using measurements of object properties and associated text and image materials and comparison to reference and historical data. One embodiment comprises a software system usable at a client with many users (for example, members of a household) or a server (for example, a cloud server that may support multiple clients) that supports collection and modeling activities using a variety of modalities, including textual and contextual analysis of samples, and analysis of the contents having particular phraseology not apparent in historical sources as well as images to identify points of origin or manufacture and, possibly, time-varying data, for example, transit routes of objects from a point of origin such as shipping data for an item (or, for example, associating a particular automobile to its source or origin of manufacture or its maintenance and accident history). Each measured property can help locate or identify the source of the object or predict other object properties if reference data with known or measured characteristics are available. While a single property such as identification of manufacturer or location of manufacture of a product or source and means of its shipment and tracking may not provide sufficient discriminatory power, the fusion of information associated with multiple measured properties collected automatically from a plurality of related databases (for example, via a special purpose cloud server) is more likely to lead to an accurate object characterization and prediction of other object properties that may further include date and time or schedule, quality and pricing data for the product or service under investigation.

Similarity-based search technologies are incorporated into database and modeling software embodiments that support model-based inference of properties of objects from a database of information gathered from previously analyzed objects and samples. An anticipated structure of this software is provided in the subsection title “Detailed Discussion of Embodiments.” The software may operate as an overlay to a Commercial off-the-Shelf (COTS) database product that supports SQL queries across a standard network interface. The MySQL database software from Oracle may be utilized for this purpose; (refer to http://wwv-vv.mysgl.org/ for further information).

The location and identification of documentation errors are described and exist in the published literature for certain objects such as among comparisons with related objects, products and services. Multivariate statistical analysis, based upon principal component analysis (PCA) methods, can be used to extract the data most relevant to localization from the raw document data comprising, for example, an NFC tag, a product cost estimate, a product image, a shipping manifest or a service quotation document including a bill of material. The extracted content can be utilized to organize a database of information about objects in a manner that supports nearest neighbor search strategies based upon measures of similarities between objects. The methods are highly efficient because of the in-memory database index. The enabling information technologies for this approach are described, for example, in U.S. Pat. Nos. 6,741,983, 7,272,612, and 7,454,411 incorporated by reference herein as to their entire contents for all purposes. An overview of one of the technologies is provided below in the subsection titled “Multivariate Statistical Analysis and Data Clustering”. Another method indexes information using partitions determined by entropy and adjacency measurements or functions. These patented methods have been used to construct several different types of databases that implement similarity-based search strategies as will be described below for content-based image retrieval (CBIR) databases. As will be discussed herein, by way of example, databases of data of different types for a given object may contain previously collected and stored data of each type in an image database, a multi-dimensional document or information database and a product or service property database. Other databases having data of different types may be, by way of example, one of time series and frequency series data, for example, the maintenance, repair, component wear and failure record for a machine, vehicle or process, for example, pipe, pump or valve failure or wear or electrical system failure such as power (battery) when questioning an automotive service repair estimate.

A reference core database for known products and services utilized by a user may preserve both product and service information and citations to the sources, such as internet links or document sources (for example, catalogs or the internet) and, when it is available, linkage to supporting imagery for later comparison to target samples using content-based image resolution CBIR. Other known methods of image enhancement, registration, segmentation and feature extraction are available in the published literature and can also be used.

Measured properties of objects and entrained materials can be utilized, in conjunction with a database that supports search and retrieval based upon similarities among objects, to provide information about products and services found similar to those of a given input document and time varying data about the object and to predict further properties.

CBIR is a relatively new technology that has undergone rapid evolution over the past decade. An early application is discussed by A. Oakly; see A. Oakly, “A Database Management System for Vision Applications,” Proceedings of the Conference on British Machine Vision, vol. 2, 629-639 (1994), using Manchester Visual Query Language to distinguish two microfossils using a projected circular Hough transform in a microfossil image. The effectiveness of CBIR is dependent upon the range of image content that must be searched. For example, object recognition systems tend to exhibit reasonably good performance with adequate lighting and standardized profiles and image geometries (for example, the full three-dimensional object views with flat lighting that are typical of catalogs, internet sites and advertisements). In contrast, a system that uses actively controlled cameras in an outdoor environment to acquire data from uncontrolled subjects tends to have a poorer performance (for example, data obtained from cameras at a ski area to determine weather and ski conditions at the ski area).

As will be explained herein, CBIR in one embodiment is based on prior work on preferential, or model-based, image segmentation, and can be used to focus upon those portions of an image (for example, apertures and sculpturing on certain forms of products having such features) most likely to lead to accurate identification, and the use of similarity-based search strategies to determine reference objects with similar features. A successful system may identify and focus upon similarity among features of products and services that have a reasonable probability of identity. These data can then be used in a search for similar competitor products and services and an investigation of error resolution achievable by the competitor as distinguished from the product or service provider source of the input document.

The extracted content from an original input document (including, for example, an NFC tag) can be utilized to organize a database of information about properties of objects and to predict further properties in a manner that supports nearest neighbor search strategies based upon measures of similarities between objects. Information about similar reference objects from the database can then be utilized to estimate or predict properties of an object and the object itself. New objects can be treated as new information and incorporated, with appropriate review, into the product or service database, to be used to link to and identify future objects with similar properties. This allows the reference data collection to grow as analyses are performed and maintain currency. The database search and retrieval methods are highly efficient because of the in-memory database index. The database may include metadata, such as information about date and time, and source data such as manufacturer and/or vendor, or location of an object when this information is available. A database search and retrieval operation provides access to the metadata of objects similar to an unknown target object, which provides inferences about the point of origin for each new object analyzed and searched. By similarity, as used in the application, is intended, by way of example, the probability or likelihood that two objects are related by at least one property.

Multivariate statistical analysis presumes that one or more portions of the measured characteristics or properties of an object can be expressed as a vector, or ordered sequence, of numbers (of which a large number may be required). Values indexed by time (time series) or frequency (spectra) are two examples of such data. A measured concentration or intensity as a function of position, time or another independent variable. While such an ordering may not be appropriate for all measurements of a sample (for example, images, time- or frequency-series, quantity, quality and price are not always encoded in a single vector), it is usually possible—and preferable—to represent one type of measurement as a vector, where several measurement vectors (of different types) may be associated with each object. Methods such as principal component analysis and clustering algorithms (for example, k-means) can be applied to each type of vector, and the methods described by the above-referenced patents incorporated by reference can be used to create databases (indexed collections of measurement data) for each vector type.

A single measurement vector, for example, a product or service spectrum of products and services, may not by itself be especially informative of an object's identity or location or time varying activity. However, the measurement can narrow down the set of possible origins or other properties, typically by excluding those reference objects that are substantially different and other measurement types can be used to refine the inferred source or property.

Thresholds can be utilized to exclude reference objects from search results if their recorded results are significantly different from the tested document sample's values—or accept (meaning one cannot exclude the reference object based upon its likelihood ratio), or leave undetermined if no ratio is available. The results can be combined by returning only those reference objects that cannot be excluded using at least one ratio, and that are not excluded using any ratio for further analysis.

According to an aspect of an embodiment, multivariate statistical analysis and clustering are utilized to extract information from a source document that is most relevant to the object from raw data sources, which may assist in determining location or time varying activity with respect to an object. Second, search and retrieval operations are based upon the similarities between objects, and clustering of objects and not necessarily an exact match to a value in a stored record's field, but rather an inclusion of that value in a specified range or a probability or likelihood that a value extracted from a product database, product provider database, service database, service provider database or an image recognized as an object is the item sought. Third, models can be applied to the metadata, or properties, associated with reference objects to predict properties of interest for a target sample including competitive providers of goods and services.

The models may be single- or multivariate and may be utilized to interpolate the value of value set of a property of an object of interest for values for the same property of similar objects retrieved from the databases. In this case, the property may be, provided by way of example only, a location or source of manufacture, the classification as to subjective quality of product or service as provided, for example, from a veritable source such as a Zagat survey of restaurants. The models may also be statistical, or Bayesian, such as a Bayesian network or belief network that relates a set of objects retrieved from the database with an object of interest. This is but one set of exemplary models that are graphs or directed graphs, as are well known in the field of computer science which can also be used. In this case, the predicted property may be, for example, the likelihood, probability, or belief that the target object and the retrieved objects satisfy a postulated relationship, or a set of likelihoods, probabilities, or beliefs determined across alternative hypotheses. If only two hypotheses are postulated, this set of likelihoods may be expressed as a likelihood ratio. Examples include the identities, command structure, or purposes of individuals, devices, software components, or other entities such as businesses that communicate via a network, relationships among individuals providing a service and potentially the detection of individuals or other entities engaged in an illicit enterprise. The embodiment further may include image information, which is necessary for identification of two to three dimensional objects including, for example, vehicles, articles of clothing, appliances and other products and related services.

The models may incorporate optimization. One example is the utilization of optimization such as least squares or maximum likelihood optimization methods that are well-known in the art to determine a model that best fits the values of one or more properties of objects that result from a database search. This optimized model can then be used to predict at least one property of a target object. A more complex example is the use of a database of time series data or data indexed by frequency, such as price, expected life and quality, obtained from measurements made on a physical process such as a heating or air conditioning or vehicle failure issue. In order to determine or localize a worn or failed component in the process, one may record measured data in a database that supports similarity-based or nearest neighbor search at various times during the operation of the process. These recorded data form a historical record of the operation of the process, and recorded measurement data from a current operating period can be utilized as a target in a search of the historical data. Results returned from a search have similar characteristics to data from the current operating period and can be used to model or predict the status, such as wear or failure mode, of a component in the process, or to model or predict the future behavior of the measured process. For example, similar time series data from the historical record can be utilized to develop an impulse response model of the process in order to predict future process state as a function of time and/or future measurement values. In this case, the impulse response model can be obtained by solving a quadratic programming optimization or convex optimization problem. Other methods such as dynamic matrix control, quadratic dynamic matrix control, model predictive control, and optimization of linear matrix inequalities can be utilized. The database would be queried to determine the measurement data from the historical record that are most similar to current conditions, determined by measurement, such historical measurement data utilized for parameter identification. In these cases, the predicted or inferred characteristics of a target object are utilized to subsequently control a physical process.

For example, with respect to a financial application such as credit card invoice or transaction errors, banking service errors (unidentified service fees), the correlations between time series can be used as a measure of similarity (for example, R²) in statistics. One would look for exploitable patterns—banking fees that appear over time such as monthly intervals, or that may have correlation delayed in time with respect to another. Principal component analysis can be used to cluster similar time series, corresponding to financial charges that behave similarly—such as compound interest charges on credit card transactions or minimum balance requirements. The model can be a method of portfolio analysis—in other words, an optimal allocation strategy to determine the best allocation of investments and assets (as well as liabilities). See also data mining, below.

With respect to data mining, the method can be used to mine information in a database—looking for clusters of similar behaviors in product or service provision. This can be purchasing patterns of the user versus other consumers of products and services, or of businesses. A model can be applied to some or all of the members of a cluster (similar objects) to determine their relationship. The model can be a Bayesian or belief network, or a pedigree, which is a graph of hypothetical relationships between objects. Relationships can be flows of capital or products/services between members of a cluster (or a subset of a cluster). Multiple hypothesis testing or maximum likelihood estimation can be used to determine which relationships (models) are more (or which is most) likely. Similarity-based search can determine objects in a database that are most similar to a target, or objects most similar to each other. By exploiting the high speed of the database, one can perform a search of the database against itself to determine a list of the most similar clusters or subsets of objects and apply models to these to test hypotheses. The results of this procedure can be used to add information to the database, which could be “metadata”, or data about the data (clusters), mining the database for knowledge.

With respect to detection of patterns in erroneous data activity, behaviors (objects in the database) may be suspicious transactions that are observed, reported or recognized, if possible, during the transaction itself and immediately resolved. Hypotheses may be the possible organizational structures of a product or service provider network or conspiracy. Similarity based searches may be used to detect patterns of criminal or fraudulent activity. This could also be interactions among computers or communications devices such as nodes in a communications network, where the goal is detection of organized behaviors. Transactions could also be medical records or medical data such as disallowed medical claims for reimbursement from private insurance or Medicare, where the goal is detection of patterns of activity indicative of improper denial of claims at the local client for a given household member with assistance of the special purpose cloud server (for example, Microsoft Azure or Amazon Web Services Structured Query Language (SQL) server) for maintaining historical data of the carriers with respect to similarly coded medical transactions, prescription drug services and other medical services.

An embodiment of the error resolution system of the present invention presumes utilization of a local client processor and memory to establish a user profile that may be personal to the individual. As will be further described herein, a user to be able to resolve errors must at least input data for resolving at least one error by establishing a user profile at a local client for each member of a household. In one embodiment, a local client is an NFC equipped mobile telephone capable of establishing communication with a cloud-based server to verify transaction data such as identity of product and applicable sales tax in a given jurisdiction. The establishment of a user profile is well known in the art but an embodiment of the error resolution system goes beyond the typical user profile. Examples of links within the client processor are links to most data stored in the system including name, address, social security number, passport data, driver's license data, citizenship, allergies, services used and links to related documents (plumbers, carpenters, auto repair dealer, electricians, termite inspectors, tax returns, medical records including invoices, bank accounts, credit card accounts, internet services such as Amazon, eBay and Alibaba and internet account access information including user names and passwords), tax program records (for example, Turbotax), state property tax records (personal property and real property), medical, education, employment, military, organizations, club memberships), user names, passwords, internet links and the like. The error resolution system may establish local, internal client links to prior tax returns, social security records, medical records, bank and credit card account history, organizational records, educational records (transcripts, degrees), personal property inventories and images (including personal images and images of personal property and valuations) for each household member treated individually (or collectively as needed). The error resolution system then populates product, product provider, service, service provider and image databases, determines competitors for product provider and service provider using known search engines such as Yahoo, Bing and Google, typically at the server level and applies data mining to retrieve product, product provider, service and service provider data to further populate the respective databases at the server or client level (depending on need). As new data is received by the client through, for example, data input or scheduled or periodic data retrieval of product and service competitor and personal profile data, the respective local databases are populated and updated and the server databases are queried for solving local document error issues.

Once a new document is received or a new transaction is likely through NFC, data may be entered via NFC tag or scanning and storing as a pdf, input manually, received via the internet, imaged with a camera and the like, the input data is parsed, qualified and is scanned for errors. If there is a significant error above a certain threshold cost value as determined by modeling possible outcomes from the error, the error resolution system may automatically proceed to resolve the error by, for example, using on-line access to internet services and, if needed, to the cloud server as it negotiates with, for example, an NFC equipped transaction terminal. The error resolution system may, for example, compose a predicted dialog with the NFC transaction terminal to resolve sales tax errors or for an on-line chat line or other dispute resolution system of a product provider or service provider and make a first attempt at resolving an error automatically. The error resolution system awaits input of a response and determines if the error has been resolved, preferably, at the transaction terminal. If not, the error resolution may repeat the attempt to resolve the error in view of the response. If the error cannot be resolved at the NFC transaction terminal level, the user may be warned via an alarm or displayed warning message. The error resolution system may attempt resolution two times (or N times) and then escalate the error resolution to a next level which may involve the composition of a communication to the product or service provider setting forth the facts and the requested resolution. To do so, the error resolution system may refer to obtain supporting information from state and federal web sites queried by a cloud-based server for gathering such data to determine the legalities associated with the error which may amount to consumer fraud. A final step, if no resolution is achieved, is to compose and transmit a communication to the Better Business Bureau, a consumer rating service or related entity to at least publish the error and resolution sought if not obtain assistance to resolve the error without creating a libel, i.e., in any such communication, the true facts will be stated and care is taken to assure that no comments are constructed automatically that may be misconstrued.

The client may comprise an artificial neural network in the form of a dynamic neural network array or a neuroscience inspired dynamic artificial neural network simulated on a standard processor (such as a personal computer or mobile communications device equipped with NFC). Certain functions may be performed in the “cloud” by a server such as structured query language searches for information on products, product providers, federal, state, jurisdictional sites and sites of products, services and service providers, maintained in a standard database and indexed and then downloaded to the client from the cloud-based server for local use as needed (but such common data may be shared by many different client networks). All communications via external internet sites and all data preserved in local client product, product provider, service, service provider, personal profile and image data must be preserved and protected in accordance with known security algorithms and firewall protection offered by the operating system and proprietary security algorithms.

These and other features of the present invention will now be described with reference to the drawings and the following brief description of the drawings. All references discussed above and throughout the present patent application should be deemed to be incorporated by reference as to their entire subject matter.

### BRIEF DESCRIPTION OF THE DRAWINGS

One embodiment of a method and apparatus for locating errors in documents via database queries, similarity-based information retrieval and modeling to resolve the errors and, in particular, to the application of database and modeling software supporting model-based inference of erroneous data recorded in at least one of a plurality of databases of information including a resolution of the issue which may relate to, for example, fraud will now be discussed in the context of the following drawings wherein:

FIG. 1 is a Venn diagram showing selected reference data from three similarity searches and their juncture or overlapping region.

FIG. 2 is a graphical overview of the architectural components of a client-server database supporting similarity-based indexing, search and retrieval according to one embodiment using multiple search engines.

FIG. 3 provides sample “s” attribute vectors associated with stored objects and a target object denoted by “x” defined by first and second principal component vectors forming a cluster.

FIG. 4 illustrates a modeled behavior for the cluster of FIG. 3 using data from selected reference objects (o, *) to estimate the property's value for target object x of FIG. 3.

FIG. 5 provides a graphical depiction of a database index constructed from the results of multivariate statistical analysis and a ranking strategy.

FIGS. 6A, 6B and 6C shows partition of a 2-level indexing tree wherein FIG. 6A shows a partition at level 1; FIG. 6B shows a partition at level 2; and FIG. 6C shows a final partition.

FIG. 7 shows a triangle inequality.

FIGS. 8A, 8B and 8C shows a search method using reference points wherein FIG. 8A shows a reference points P₂ and P₃; FIG. 8B shows reference points P₁ and P₂; and FIG. 8C shows reference points P₁ and P₂ from FIGS. 8A and 8B.

FIG. 9 shows a performance comparison of two data extraction methods.

FIG. 10 shows a process for entry of profile data to a user profile database for each user of a given client (for example, personal computer including processor and memory) to distinguish relationships and identities of individual users of the present invention, an image database entry for images of the user is also assumed.

FIG. 11A is a first diagram of an overall process of document error recognition and error resolution and FIG. 11B is a continuation of the overall process to error resolution.

FIG. 12 is a diagram showing product or service data input to a product or a service database which are coupled to at least one product provider and at least one service provider database assuming one particular product and one particular service.

FIG. 13 is a diagram showing product or service data verification for the purpose of identification of document errors and issues in product or service documents.

FIG. 14 is a diagram showing a first stage of error resolution wherein the system of the present invention and special purpose client and server processors may engage, for example, a chat line, customer query or dispute resolution process to resolve the document error or issue.

FIG. 15 is a diagram showing a process of document error or issue escalation which may, for example, be repeated or, if successful, reach a successful resolution and, if unsuccessful, the system may recommend a movement from a given product or service provider to a competitor product or service provider.

FIG. 16 is an overall block diagram of a neuroscience inspired dynamic architecture (NIDA) which may be simulated on a client or server special purpose processor for performing the document error identification and resolution processes of FIGS. 10 through 15 along with the embodiments of FIGS. 17-21.

FIG. 17A is an 8 bit diagram and FIG. 17B is an example of a 16 bit processor diagram of a hardware implementation of a dynamic neural network array (DANNA) having a selectable neuron and synapse operation and direction of synapse so that the DANNA may learn and adapt to changing external influences over time. A DANNA is preferably an outboard hardware system to supplement either the operation of a client or a server, for example, per FIG. 2.

FIG. 18 is a further diagram of a DANNA showing how the DANNA may adapt under interface and control to assist in an external process of document error identification and resolution along with NIDA FIG. 16.

FIG. 19 is a typical block diagram of a known client or server having a processor, memory, a display, secondary memory including secondary memory, a communications interface and the like including an internal communication infrastructure.

FIG. 20 shows a block diagram of a data error identifier, modeler, predictor and error resolution platform.

FIG. 21 shows a block diagram of exemplary system components showing client or server with NIDA special artificial neural network processor component of a processor and an outboard DANNA of FIGS. 17-18 (8 or 16 bit processing) for Client or Server with a bus-connected data acquisition device such as a scanner for capturing documents or a camera for capturing images.

### DETAILED DESCRIPTION OF PREFERRED EMBODIMENTS

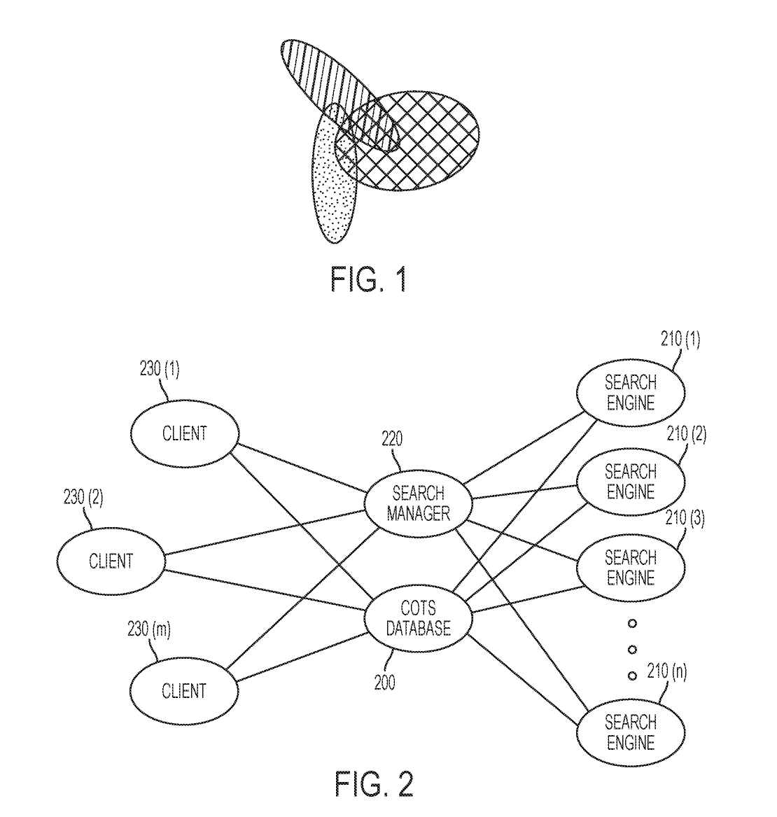

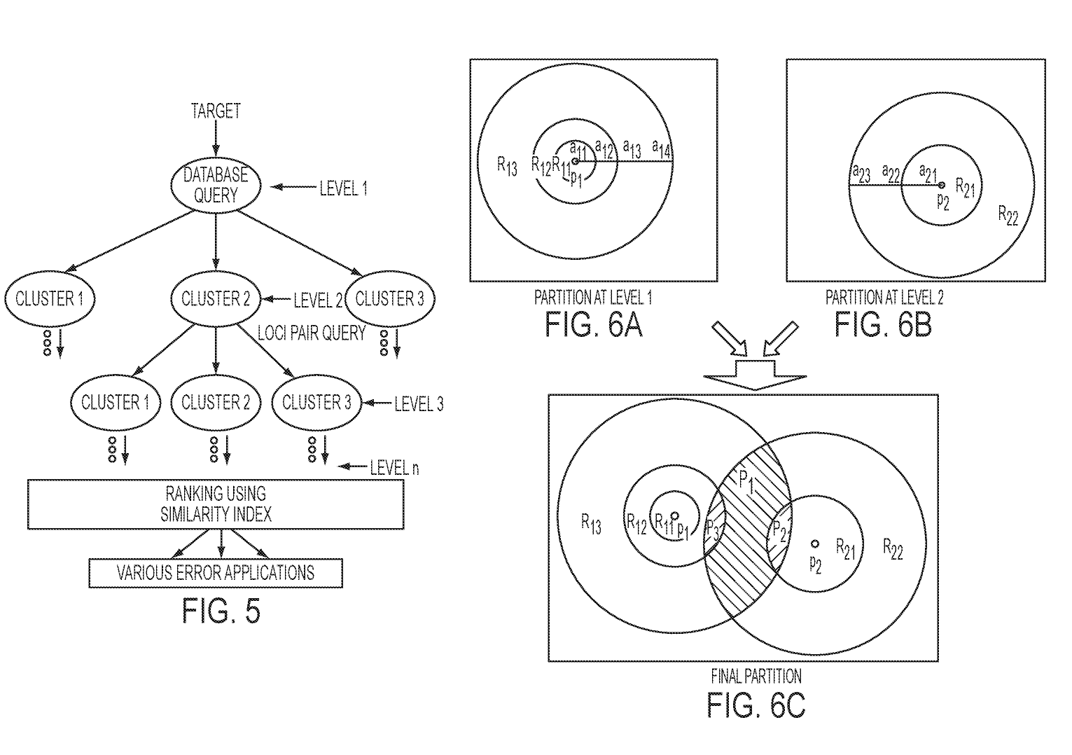

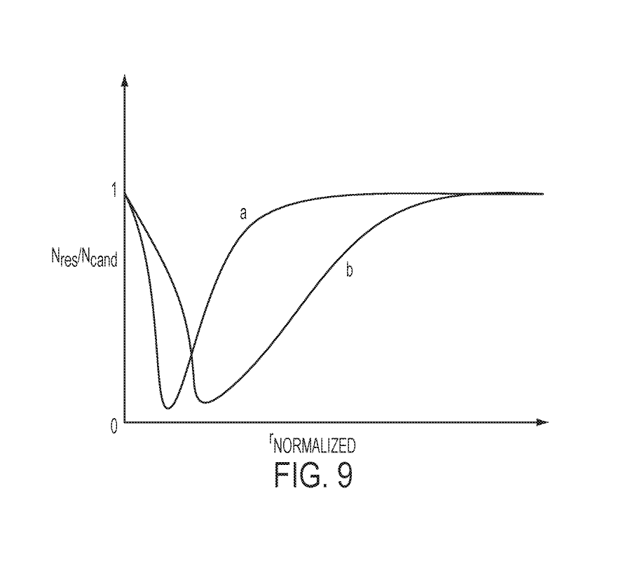

Embodiments of a method and apparatus for locating errors in documents, particularly, financial transaction related data, via database queries, similarity-based information retrieval and modeling to resolve the errors and, in particular, to the application of database and modeling software supporting model-based inference of erroneous data recorded in at least one of a plurality of databases of information including a resolution of the issue which may relate to, for example, consumer fraud, will now be described with reference to FIGS. 1-21. One embodiment promotes the use of a federation of database indices, for example, those corresponding to the collection of historical data from related products and services utilized by a given user of the embodiment. This embodiment requires the completion of a personal profile of a user and establishment of links to relevant historical information in a client computer by the user. Previously stored data of the client computer (including but not limited to data populating a product database, a product provider database, a service database and a service provider database) can be searched using similarity-based methods for reference samples with characteristics similar to those characteristics or of a type of data measured and stored for an object. An example of an object may be a product, a competitor product, a service and a service provider and dataset entries may comprise, date of purchase, location of purchase, warranty, price, quantity, product identification such as make and model number, vehicle identification number, drug, generic drug, medical record and so on. Some of this information may be collected via an NFC tag. Other data may be generated locally by an NFC smart device including, for example, a camera and geographic position locating (GPS). Each database index may be implemented by a search engine, utilizing a common commercial off-the-shelf database or a file system as a persistent storage repository. A search management process may be utilized to coordinate requests from clients for information across all database indices, and for interpretation of the search results to present a coordinated response to each user intelligent client device.

Referring to FIG. 1, there is illustrated a Venn diagram of the selected reference data from three similarity searches. The combination and utilization of information from searches involving multiple attributes of the newly acquired target object of interest can refine the estimate of properties related to a reference document related to a product or service, as illustrated by the central intersection of the three depicted similarity searches shown as ellipses in FIG. 1. Similarity measures can be used to cluster by similarity and then apply model(s) to clusters to test hypothetical relationships—with or without a target object or object of interest. The object of interest may be a member of the database. For example, one may perform searches for similar objects contained in the database for all members of the database. A database may be dynamic, with new information being added to the database, which data can change the membership of clusters of similar data and the validity of hypotheses with respect to product or service, product provider or service provider data. In one example, a user scans an NFC tag at a store, determines the store location, determines similar product available at the store and at competitive stores and provides on screen advice about a product purchase. In another example, a service provider such as Comcast may have a web site describing/announcing old/new products/services and, in particular, products or services historically utilized by a given client consumer and as such provide new pricing and price and quality of service structures for desired services. The error resolution system of an embodiment of the present invention may locate potential errors in documents/data presented to the client and immediately identify potential documentation errors, likelihood ratios and probabilities of such errors, modeling to determine severity and impact of a probable error and begin to seek and obtain resolution of those errors automatically without user intervention.

Reference data that are tagged with properties such as the circumstances of similar product or service availability can be utilized to infer point of origin information for a newly acquired target object. For example, NFC tag data may be used to determine ecological, environmentally unfriendly or other attributes of a particular product and the client device warn the user of the purchase. Deterministic or static models may be utilized to infer these properties and predict other properties. Example models include methods known in the art of curve fitting and interpolation, least-squares models, and principal component analysis (PCA), for example, to project impact of a document or data error and to maximize error resolution. Maximum likelihood estimation methods (e.g., likelihood ratios) may also be utilized to provide a quantitative statistical assessment of the relative support for competing hypotheses (there is a serious error requiring immediate attention or this error may be ignored). Likelihood ratio analysis may require investment in the development of a reference data set because such methods are Bayesian—they rely upon a priori statistical information about the probability that samples with specific characteristics will be found at the stated locations (for example, internet web sites or stored locally on the client) or with these characteristics, properties and features. Other approaches such as artificial neural networks, belief networks and fuzzy logic may be used to advantage as will be described herein. Dynamic machine learning methods such as reinforcement learning can be used to update behaviors of the models based upon newly acquired knowledge/information from periodic or scheduled web searches. Reinforcement learning is especially relevant to voice recognition and speech to text conversion so that the user's voice may be authenticated to the client and that the textual conversion of data to be stored by the client is accurately collected for storage.

Existing technologies that enable the development of database and modeling capabilities to support source identification from document data analyses are utilized in existing systems for the dynamic indexing and storage of updated data, for example, related to product or service identification. The technologies are utilized in one embodiment to implement a more general type of database (the Core Database) that supports utilization of correlations between observed attributes and properties of reference objects to model and predict the site properties and contexts of newly acquired objects of interest.

One embodiment of a database is a product database (PD) that supports the comparison of objects of interest to a reference collection based upon measurable product characteristics such as price, size, freshness, style and, generally, quality and inference of properties and contexts of one or more target objects from data associated with similar reference objects to determine similar products of equivalent price and quality. As described above, such a database may comprise object price, source, availability, quantity, quality, comparable product and other data. Data may be collected from reference objects at frequencies (periodic or scheduled) related to the needs of a product or service consumer and over time or on a schedule such as fall fashions or a movie release schedule.

A second embodiment of a database is a product provider database (PPD). PPD supports comparison of product derived from expert study of PD objects of interest to stored reference products, and inference of properties and contexts of one or more target objects from data associated with similar products. Both PD and PPD databases are merely exemplary of other databases that may be employed to advantage such as a content-based image retrieval database (CBIR) database as will be described further herein which may contain image data related to product or service.

A third embodiment of a database is a service database (SD) which compiles data of services commonly utilized by a consumer such as transportation, credit card, banking, internet services and other service providers. Related to the SD is the SPD or service provider database comprising data for service providers that are providing the same or similar services in a geographic area of the consumer or remotely if such services have a characteristic of being remotely providable. For example, one may wish to see a medical service provider in Washington, D.C. but be willing to travel to see a medical service provider within a geographic radius of Washington, D.C., for example, in Baltimore, Md. The databases will support storage of data objects containing identifying features (products, services and images for CBIR), source information (such as when/where/from whom a product or service may be provided), and information properties and context that can be used to infer related quality and/or time-based activity. Multiple PD, PPD, SD, SPD and CBIR databases may be implemented using the Core Database technology to form a plurality of hierarchical and relational databases to improve the accuracy of the inferred properties of target objects and their probability of occurrence and schedule of occurrence (such as dental examinations).

For example, credit card services may benefit from an SPD database as described above. Since the features of credit card services related, for example, to interest rates, timely payment of minimum balances, the tracking and correlating of historical balances and purchases, rewards such as points and discounts and the like over time and even wandering outside boundaries of the given credit card service provider could be beneficial, particularly for those in the banking and credit card industry. This technology and NFC tag technology could also assist in preloading coupons, rewards, discounts available from the internet before a transaction occurs. The device may determine trends in interest rates or warnings of product danger from other predictive services including but not limited to federal government banking data, consumer protection and product safety data and other data available from federal government web sites.

Capabilities can also be used to detect the movement of money through interstate and international commerce, for example, in the event a Louis Vuitton handbag is now available more inexpensively from a French web site than in the United States due to currency fluctuations of the Euro. Again, such sites as provide money market data may be queried periodically to be sure that consumer decision-making is timely and maximized.

These and other related databases may have a client-server architecture, as described in the subsection titled “Design Overview”, so both client and server software may be utilized. An example of information on site properties and context is the geographic location, date, and time of collection. However, the information may be descriptive, especially when reference materials are extracted from the literature; examples include local and regional changes in food prices, and the proximity to inexpensive product sources (of equivalent product quality). This information may exist in the primary literature such as recent catalogs, but it also may have been obtained from other sources such as the internet or on-line auction data such as Ebay or internet sales sites such as Amazon and Alibaba. Data coding can be designed to provide information in a form that can be utilized to infer the characteristics of the source of a newly acquired sample. It is anticipated that a significant portion of the client and server software will be common to both (or several) database applications. The initial databases and related software provide a base platform for other database applications in the future, including support for product and service competitor recognition. The database server and associated data processing methods may be implemented, for example, using the C++ or a similar programming language, and a client device may be implemented using Java, C# or other programming language suitable for implementation of a user interface or client program.

Tagging in the PD, PPD, SD and SPD (also CBIR) databases may uniquely identify the objects and selected properties. Multivariate statistical analysis and clustering will play a key role in identifying nearest neighbors and clustering. Matlab may be utilized to provide a rapid prototyping capability to assess design and data analysis alternatives. Clustering opportunities may determine an efficient indexing and search method to be used for the database. One approach is illustrated below, by way of example, using consumer profile data in the subsection titled “Multivariate Statistical Analysis and Clustering” (MVS). Consumer profile data are, at a fundamental level, comprise multidimensional vectors that can be processed and aggregated using methods based upon principal component analysis (PCA) and clustering algorithms.

The indexing method may be entropy/adjacency, and is not limited to MVS or PCA. These methods may be used in combination. Entropy measures the ability of a node in a database index to segregate data in a collection (subset of the database) into two or more portions of roughly the same size or complexity. Adjacency measures the ability of a node in a database index to impose structure on these portions that preserve similarity—meaning that similar objects are in portions that are similar (a hierarchical data model where if you want to search for an object near (or contained in) portion A, and if the neighborhood of results of interest is sufficiently large, you also want to search for objects in portion B (or multiple portions) where the data in portion B is more similar to the data in portion A than other data in the database. There is a trade-off between entropy and adjacency—prior work found that a substantial gain in adjacency can be obtained at the expense of a small decrease in entropy (or increase, depending upon the sign that is used—either information gained from applying the query, or entropy of the resulting portions).

Examples of indexing methods include: (a) indexing of sequences, including text (words) or characters, using a measure of edit distance, which, when properly defined is a metric (and therefore the metric space indexing methods, (b) indexing of sequences of numbers using a measure of the correlation between the sequences, such as R² or Mahalanobis distance, or inner product of vectors, (c) A similarity between labeled objects can be defined and described in a database family, (d) indexing can be based upon similar hierarchical decompositions of objects, such as the tree of shapes and shape descriptions of segments in images, and (e) 3-d structures such as most products and articles of manufacture can be indexed based upon their structural similarities, using, for example, a spanning tree of an annotated graph representing the structure, with term rewriting rules to determine similarities in structure (creating, in some applications, an equivalence relation on the set of possible spanning trees and a measure of similarity between equivalence classes). This can also be used to define the similarities in the structural descriptions of name brand drugs and generic equivalents. (f) Finally, indexing can be based upon metric space methods by embedding objects in a metric space (or associating objects with elements of a metric space) and using an inverse of the metric, such as an additive or multiplicative inverse, evaluated upon a pair of objects, as a measure of the objects' similarity.

Quality of product and service data may be collected during a survey of users (for example, Amazon four star ratings), they may be archived in a form that can be utilized to populate an operational PD or SD database as to quality. This may be compared to the point-of-sale data received from an NFC tag and a cloud-based server may be accessed to obtain related data to response to a user query. Associated quality information may be coded for insertion in the PD or SD database. There exist alternate methods of data coding for information to determine a coding framework that best suits the needs of the end user (consumer) community and supports the requirements of the extant similarity-based indexing and search technologies.

### Design Overview

This section provides an overview of the design of a database (PD, SD, PPD or SPD) that implements efficient similarity-based, or nearest-neighbor search. This means that a request to search the content of the database will return identifiers for objects that are within a specified distance to a reference, or target, object but may not precisely match the target's characteristics. One way to define the term “distance” uses a metric that is defined on the stored objects, and that can quantify the dissimilarity between two stored objects. A metric satisfies the triangle inequality, and this fact can be exploited in the design of a database index. See, for example, the section below titled “Content-Based Image Recognition” for images and text parsing algorithms known in the art to parse a document into component concepts. However, a measure of distance does not have to be a metric. For example, see U.S. Pat. Nos. 6,741,983; 7,272,612; and 7,454,411 for more general indexing structures that rely upon concepts of “distance” that are not all metrics.

Several metrics may be defined and utilized to satisfy a request to search the database (PD, PPD, SD, SPD), in which case the returned identifiers refer to objects that are within a specified distance to the target object with respect to each metric. There are performance advantages that can be achieved when the stored objects can be represented as values in a vector space and/or when a metric can be used as a measure of distance, or to define the similarity of objects, but this is not necessary and is not feasible in all applications. For example, images may be represented as values in a metric space that is not a vector space, and consumer or user profiles require a looser interpretation of the term “distance” (using mappings that do not satisfy the triangle inequality). Even in these applications, high performance databases have been implemented using the methods developed at the University of Tennessee as described in the issued patents. To enhance readability, terms that refer to components and concepts that have particular meaning in the design are printed in italics.

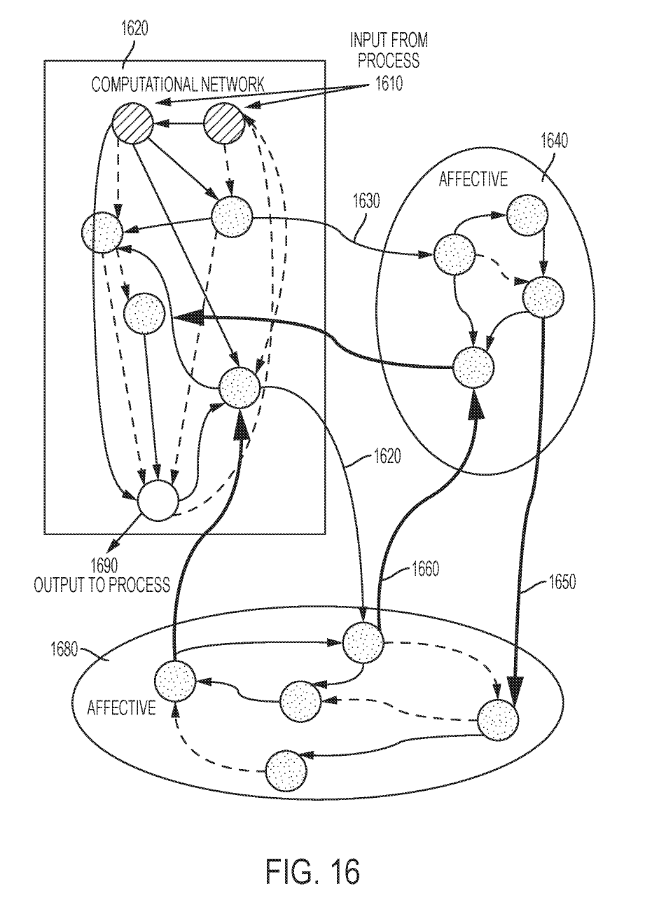

FIG. 2 provides a graphical overview of the primary architectural components of a client-server database supporting similarity-based indexing, search and retrieval using multiple search engines (Google, Yahoo and Bing, for example) and, for example, sql database queries. In one embodiment of the present apparatus for locating errors in documents via database queries, similarity-based information retrieval and modeling to resolve the errors, a client 230(1), 230(2) to 230(m) may be a laptop, intelligent mobile device, pad or other personal intelligent device equipped, for example, with near field communication and by WiFi or wireless telecommunications link to a search manager 220 and a COTS database 200 which may be cloud-based servers. The database (or preferably a collection of databases) 200 utilizes a local client-cloud server architecture that provides simultaneous services to multiple clients, networks of clients and multiple users (such as a household of users) of those clients. Architectures have been implemented that leverage the advantages of parallel computation, using both clusters of computer nodes and single nodes with multiple processors and cores. A commercial off-the-shelf (COTS) database 200 or a computer or network file system (referred to herein as a “COTS Database”) can be utilized for persistent storage, while the high-performance in-memory indexing and search technologies are implemented in Search Engines 210(1) to 210(n) that operate as cooperating threads or tasks within the overall architecture (for example, searching for competitor data for a given product, jurisdictional sales tax data, service, product provider or service provider data from one or more cloud-based servers supporting the client networks). A Search Manager 220 provides coordination between the Clients 230(1) to 230(m), a COTS Database 200, and Search Engines 210(1) to 210(n), as well as the initial connection protocol for the Clients 230(1) to 230(m). The application can be parallelized by allocating separate computational resources to each component, such as a Search Engine 210(1) to 210(n), by allocating multiple computational resources to any component, as occurs in a Search Engine 210 that utilizes multiple threads, or using a combination of these methods. Communications among components in a parallel implementation may be effected using a communications medium such as a computer network or using shared memory. The NFC communication is short distance between tag or transaction terminal and NFC client but an intelligent telephone client 230 may communicate with a COTS database 200 and search manager 220 that are cloud-based and that database 200 and search manager 220 in turn refer to a search engine 210(1) to 210(n) to collect to data applicable to a transaction in contemplation or in process. For example, the client 230 may have scanned an NFC tag for a product and determined, as necessary, by GPS, by document scanning or other activity, the tax jurisdiction of the product provider, for example, a large, nation-wide department store, and referred to the COTS database for the local tax jurisdiction of the large department store and the applicable tax. The search manager 220 may be asked to refresh the COTS database 200, for example, to determine if today (by a date and time clock) has been declared a sales tax free day in the jurisdiction. To accomplish this, the search manager 220 will query the search engine for the tax jurisdiction of the large department store to determine the sales tax applicable to the product considered for purchase, if any, on the given day and time of day and at the large department store as located by the requesting client 230 via NFC tag, bar code scanning, GPS or document scanning (or other means). The search manager 220 and/or COTS database then report the applicable sales tax, if any, for the product identified by the NFC tag to the requesting client 230. Further details of client 230, search manager 220, COTS database 200 and search engines 210 will be provided in a discussion of FIGS. 16-21.

A simple example illustrates the design concept. Suppose a product or service or image database contains 14 objects, and that each object is described by a vector of attributes that are real-valued. Preprocessing of data can be by data extraction or filtering, such as low or high pass filtering, or Kalman filtering or extended Kalman filtering (both using a model of relationships among members) or parameter identification such as product by SKU identification and price. These attributes can be analyzed using multivariate statistical analysis (MVS), for example, using principal component analysis (PCA) as described in a subsequent section, to determine a smaller dimensional (two in this example) subspace of the attribute space in which the objects can be clustered into groups (three in this example). In this simple example, assume that a measure of similarity between objects, using the projections of the attribute vectors onto the principal component basis vectors for the subspace, is the inverse of Euclidean distance between points. This situation is illustrated in FIG. 3 showing projections of sample ‘s’ attribute vectors associated with stored objects (o, *) and an unknown target object (x) onto the subspace defined by the first and second principal component vectors. The projection shows three clusters of objects, of which one contains objects most similar to the projection of the target object's attribute vector, a cluster of five “*” points at the right of FIG. 3 with the target object's vector x in the center. In FIG. 3, the rightmost cluster in the figure (containing data points corresponding to five objects) is the cluster of greatest interest.

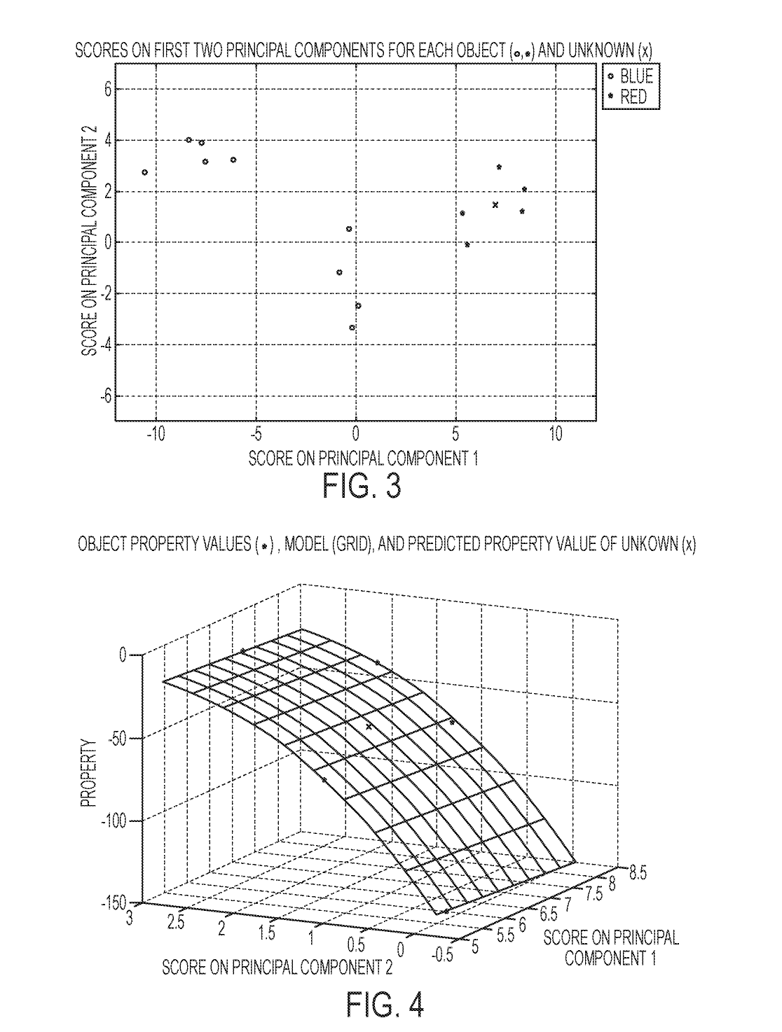

The right-most cluster in FIG. 3 illustrates the effect of a similarity search operation on the database. The point depicted by the ‘x’ symbol in FIG. 3 corresponds to a newly acquired target object, and the search operation identified five stored objects that are most similar to the target using the similarity measure defined by the combination of a projection operation onto the subspace and the Euclidean distance metric. Suppose the objective is to estimate a property of the target object from the property's values for similar objects. An example of an attribute or property might be a product's environmentally friendly nature. The client may communicated with a cloud-based server to determine environmental friendliness, data not available from an NFC tag or barcode or SKU. This is illustrated in FIG. 4, where the vertical axis represents the value of a single real-valued property. An algorithm is applied to the similar objects' data, as represented by the gridded surface, to provide an interpolated or inferred estimate of the property for the target, represented by the vertical height of the ‘x’ symbol in FIG. 4 (toward the center of the curved planar space).

A feature of the technical solution of an embodiment is the ability to rapidly select objects from a large database that have similar attributes to those of a target object of interest, even when the database contains millions to hundreds of millions of objects. This enables the rapid modeling and prediction of a target object's properties using data from the set of similar objects.

The remainder of this subsection provides a brief overview of the concepts utilized to construct database indices that support similarity-based search and retrieval methods, after which the basics of the statistical analysis and clustering procedures utilized in the indexing method are presented.

### Views

One aspect of one embodiment of the database architecture is the View, which provides the basis for the implementation of a Search Engine. Referring to FIG. 2, there may be a plurality of Search Engines 210(1) to 210(n). The COTS Database 200 of FIG. 2 can contain an arbitrary collection of stored objects, which can be arranged in a relational structure that, although a factor in the performance of the database, does not have a direct relationship with Views or Search Engines 210. For each View, a specification determines the set of objects in the COTS Database 200 that can be accessed using that View, called the Viewable Set. This means that in general not all stored objects may be accessible from a single View. This is reasonable, since some objects can have, for example, images that are indexed using information derived using a View, while other objects do not.

A View includes a specification for an Attribute Set, which is the set of attributes that can be extracted from any object (for example, product, service or image) in the Viewable Set. An attribute value can be any data structure; examples include vectors, sets, and trees of data objects. For example, a “tree of shapes” description and organization of the segments that correspond to a portion of an image can be an attribute value. In, for example, a product database the attribute value may be a collection of features of the product, a size attribute, or a price attribute associated with loci within a product database. At its most trivial, an attribute value is a number or a symbol. The Search Engine 210 that utilizes a View indexes its attribute values, and the attribute values are stored in the Search Engine's address space. Attribute values are derived from stored objects and can be utilized for rapid comparison of the objects, but note that while two identical objects will have identical attribute value sets, identical attribute value sets do not imply that their corresponding objects are identical.

A View defines an Extractor, which is an algorithm that can be applied to a stored object within the Viewable Set to produce one or more attributes, each of which is a value in the Attribute Set. The Search Engine associated with a View typically applies the Extractor to all stored objects that are in the Viewable Set (as they are stored), and therefore contains within its address space at least one attribute value for each stored object.

A View defines at least one Partition on the Attribute Set. Each Partition defines a Function from the Attribute Set to a finite set of categories, or labels, and optionally to a metric space. A metric space is a set of values that has an associated distance function d(x,y) that assigns a non-negative number, the distance, to every pair of values x and y in the metric space. The distance function must satisfy three properties: (i) d(x,y)=0 if and only if x=y for all x and y, (ii) d(x,y)=d(y,x) for all x and y, and (iii) d(x,y)+d (y,z)>=d(x,z) for all x, y, and z. If the metric space is defined, the Partition assigns a category or label to each element of the metric space. Typically, this assignment is accomplished in a manner that allows an efficient implementation of an algorithm to compute the category associated with any value in the metric space. The Search Engine 210 utilizes Partitions to implement a “divide and conquer” search and retrieval strategy, isolating possible matches to a specified request to search to subsets of categories and implementing a tree-structured index to leaf nodes that contain attribute values and identifiers of stored objects. The advantage of this approach over the capabilities offered by traditional database technologies is that it supports indexing methods that allow similarity-based search and retrieval and depend upon both multivariate and multi-valued (set-valued) quantities; two examples are described in U.S. Pat. Nos. 6,741,983; 7,272,612; and 7,454,411.

The Function typically implements one or more data reduction steps, such as are described in the section titled “Multivariate Statistical Analysis and Data Clustering”. The intent of the data reduction steps is to determine a minimal set of attribute values that enable efficient partitioning of the stored objects into disjoint collections of roughly equal size, and, where feasible, to cluster like objects by assigning similar attribute values. Therefore, the Function can effect a transformation of the information associated with the stored object into a useful form that enables at least one of clustering, partition and indexing. As described later, this is typically accomplished through a combination of proper selection of data encoding methods and statistical analysis, either using previously acquired and stored data or using a dynamic process as new data are acquired and stored.

### Properties

Properties are similar to Views but are not utilized to construct indices or Search Engines 210. A Property has specifications of a Viewable Set of objects and an Attribute Set of attribute values that those objects may possess. Unlike Views, attribute values associated with objects are provided by an external source rather than computed by an Extractor. For example, an attribute value can be a manufacturer of a product or of a competitor product. A typical application would attempt to infer property values for newly acquired objects using a search for similar objects stored in the database 200 and a model of how property values vary or correlate with other attributes of the object.

### Search Engines

Search Engines 210 implement high-performance indices for the database 200 of stored objects that allow objects similar to a specified target to be located and retrieved, such as competitors, competitive products and competitive services and locate properties and attributes of such. Each Search Engine 210 corresponds to at least one View into the stored data. (An example of a search engine that utilizes two views is provided in U.S. Pat. No. 6,741,983, where a partition can utilize information from two (or more) different sources of similar data.) Two possible Search Engines 210 implement indices of data, for example, image data (dental x-rays, MRI's, product photographs, collision event photographs and the like) and time series data, i.e. property data of a type for comparison with like previously stored data. A Core Database 200 functionality is capable of supporting more advanced Search Engines 210. For example, a first Search Engine 210 may be defined that indices surface sculpturing on images of cancer cells, allowing reference cancer cell data to be retrieved that describe cancer cells with similar texture to a target sample. Other Search Engines 210 may be defined to index the data based upon overall shape, size, and physical attributes such as apertures (for example, holes in clothing or chips or other aperture defects in pottery products). Still other Search Engines 210 may be defined to index the data including rating characteristics among various data received or obtainable, for example, via a web site such as Amazon (provides product reviews), Yelp and Angie's List (providing service reviews) or alternative web sites describing/picturing the same/similar product or service and a subjective/objective rating (possibly by an expert system or special label, for example, Underwriters Laboratories).

Referring again to FIG. 2, a Client 230 can specify a search context that requires similarity, for example, in size, shape, apertures, style, make, model, quality and texture, which would be interpreted by the Search Manager 220 to require searches using multiple indices (Search Engines) 210 and subsequent analysis and combination of the results. There may be a plurality of Clients 230 working together, for example, an intelligent device's access to a personal computer in a user network. For example, a reference to a stored object could be returned only if it were similar to the target object in at least M of the N attributes where N is the number of attributes allocated to a product or service. Another Search Engine 210 could implement an index into product or service data obtained from physical components, retrieving information about stored objects of that type that have similar attributes. Information describing both types of objects (and others) can be stored in the underlying COTS Database 200, whose primary functions are to implement persistent storage and provide the usual capabilities of a relational database.

Each Search Engine's index is tree-structured. Operations begin at the tree's root, and paths of descent from each node of the tree are excluded if no possible matches to the current search specification and target can exist on those branches. Leaf nodes of the tree contain attribute information and references to objects within the COTS Database 200. The attribute data can be used to exclude many referenced objects as possible matches, leaving a small number of objects that require additional analysis—and possibly retrieval from the COTS Database 200—to determine the final set of matches. In some cases it is possible to maintain a complete copy of each object within the address space of the search engine, if this is required for high performance applications. The Search Engines 210 can support multi-threaded operation, allowing the simultaneous processing of requests from multiple clients (different or the same household), or from a single client that has submitted several requests for product or service data. In one embodiment, write operations, which store new data in the COTS Database 200 or modify the index structure, block other queries to maintain the integrity of the index structures. These operations require coordination across Search Engines 210, or within the Search Manager 220, because a write initiated in one index may require modification of data within another index that can access the same object(s). An alternate embodiment allows non-blocking writes with subsequent coordination among processes that access overlapping information sets to resolve conflicts or inconsistencies. Referring to FIG. 2, the Search Manager 220 is shown connected to both Clients 230 and Search Engines 210. In FIG. 2, the search manager and COTS database connections to the clients must be secure according to known technologies such as personal user name, password, answers to personal questions (mother's maiden name), and the like. Each of Search Manager 220 and Cots database 200 may be cloud-based servers (for example, Microsoft Azure, Amazon Web Services or Google cloud servers), and these in turn may access known search engines, for example, internet search engines including but not limited to product search engines, service search engines, product provider search engines and service provider search engines as well as known search engines such as Yahoo, Bing and Google.

### Models

The utility of the similarity database lies in its ability to predict characteristics of newly acquired examples of products and services (for example, the entry of Alibaba into the space of on-line product and services) or a new “brick and mortar” local store as a source of products and services using a cumulative database of previously gathered and analyzed materials. For example, the advent of a new hardware or department store making available an Anchor brand cake plate similar to one advertised on Amazon where the value and duration of the shipping by Amazon makes the cake plate more expensive in time and money than the one at the hardware/department store needed for the party planned for this evening. It is sometimes unlikely that an exact match will be found to any particular target, but it is possible to model Properties of the new sample using the Properties of similar stored samples. An example is a search conducted for a personal electric toothbrush at Amazon was unable to locate a match for an electric toothbrush purchased and used by one member of a household by another member of the household. A search through Google found the exact toothbrush. Amazon located competitor toothbrushes having alleged five star ratings for less money. This product/service matching may be accomplished using interpolation and either deterministic or statistical models, which may be either single- or multi-variable models, or more complex models may be utilized, as described earlier. The similarity search becomes the first step in this process by restricting consideration of previously stored object data to those that are most similar to a target object.

A Model includes a specification of Properties, which identifies the Viewable Set of stored objects to which the Model can be applied and the Attribute Set that can be utilized by the Model. The model also specifies an Algorithm to be used to compute values of a subset of the Attribute Set for a target object, given a set of stored objects and the target object. The Model may incorporate an optimization method or an approximate optimization method to adapt or fit the Model to a subset of stored objects in the Viewable Set. Note that the attribute values can include computed estimates of errors, in addition to the estimates of values such as geographic location, manufacturer, or geographic characteristics such as expected nearby product or service access.

An important feature of a Model is its ability to adapt to new information. As additional objects are acquired, analyzed, and stored in the database, their associate data are available to the Model's Algorithm. A search for stored objects and inferred information relevant to a new object is expected to provide more precise answers as additional data are acquired and stored in the database system. In all cases, the Model should utilize current stored data from objects that are most similar to a target object's characteristics to develop inferences, predictions and projections, for example, of costs of an input document or data error.

Filtering can be used to assess the quality of a model's fit to data (degree with which it accurately describes the relationships among the objects). For example, one can examine the residuals or innovations processes in filters to determine how accurately the filters model or match the behavior of the group of objects. These filtering methods are well-known in the field of electrical engineering (subfield of systems and controls), and are also utilized in statistics and business applications. One example of filtering is in real estate web sites and using filters such as bedrooms, baths and garage to narrow a search for a property in a specific area.

Similarity measures can be used to cluster by similarity and then apply model(s) to clusters to test hypothetical relationships—with or without a target object. The target may be a member of the database 200. For example, one may perform searches for similar objects contained in the database for all members of the database 200.

### SUMMARY

A purpose of the present design is to provide a predictive modeling capability that is based upon collected reference data. The collection is dynamic: As new objects are stored in the system, the quality of inferences improves. The design is not bound to a single modeling paradigm: Models may be as simple as a linear interpolation or a lookup in a database table, but they may be much more sophisticated, using multivariate data and optimization, and restricted only by what can be coded in a standard programming language to utilize the structured data associated with stored objects. Similarity based search enables the Models to utilize the data that are most similar, using multiple factors, to a target object, and, since all stored data are available to the Search Engine 210, the most recent data are utilized, allowing the predictive modeling capability to remain up to date at all times. The patented and patent pending technologies that have been developed at the University of Tennessee allow high-performance similarity-based search strategies to be effectively implemented even for very large data collections, with demonstrated scalability into the hundreds of millions of stored data objects and demonstrated performance of hundreds to ten thousand completed searches per second utilizing readily available off-the-shelf hardware.

### Multivariate Statistical Analysis and Data Clustering

Now a method that uses multivariate statistical methods to determine clusters is described that can be utilized to partition portions of a database into groups with similar properties and of roughly equal size; see, for example, U.S. Pat. No. 6,741,983. As a result, this method generates partition information that can be incorporated within or associated with an arbitrary node in a tree-structured database index. The figures are from applying this method personal profile data based upon locally stored personal profile data as well as to product, product provider, service, service provider and image data.

The raw data associated with objects to be stored (or retrieved) in the database 200 are represented as vectors of numbers. For the various client databases, these numbers are preferably binary and represent the presence (binary “1”) or absence (binary “0”) of a specific product or service. This encoding scheme is often used for measurements that assign categories, such as “rough”, or “elliptical”, or that represent the presence or absence of features in raw data, such as price data. Measurement can also yield floating-point, or real, values, in which case the raw values, either scaled or un-scaled, can be utilized (for example, data as to product life or service life expectancy). Principal Component Analysis (PCA) of the data is utilized to decrease the dimensionality of the raw data by identifying directions of maximum variation in the original data and transforming the data to a new and lower dimension coordinate system. For use in a database, coordinates are desired that result in discernable and clusterable patterns in the reduced data space. Distinct clusters, usually less than 10, can be established using a clustering method, such as k-means; see, for example, J. T. Tou and R. C. Gonzalez, Pattern Recognition Principles, Addison-Wesley, Reading, M A. 1992 or k-modes or k-prototypes; see, also, Z. Huang, “Extensions to the k-means Algorithm for Clustering Large Data Sets with Categorical Values,” Data Mining and Knowledge Discovery 2, 283-304 (1998). The membership of each cluster is then identified and recorded. In the present error resolution application, each personal profile belongs to one and only one of these clusters. Thus, all of the personal profiles in the database can be partitioned into these clusters. This partitioning occurs at each level of the tree-structured database index, enabling a “divide-and-conquer” approach to data retrieval. When searching for data matching a target's characteristic, the target can be classified into one of these clusters at each level of the tree. A subsequent search can be restricted to members within this cluster. This reduces the search problem by approximately one order of magnitude at each level of the index tree, as the search descends the tree.

Principal component analysis (PCA) is a method for analyzing a matrix of high dimension, revealing correlated information and representing it with a much lower dimensional matrix without sacrificing significant information contained in the original data matrix. PCA involves a rotation from the original frame of reference to a new frame of reference, whose axes are given by the principal components from the PCA. The first principal component represents the direction along which the variance exhibited by the original data points is maximized and is made up of a linear combination of the original variables. The second principal component, orthogonal to the first, represents the direction along which the remaining variance is maximized. Additional principal components are defined in a similar fashion.

To implement PCA, the Singular Value Decomposition (SVD) method can be used to decompose the data matrix, X, into the product of three matrices, in which the columns of the matrix, V, are referred to as the “principal components” of the SVD of the data matrix, X; see, for example, G. Strang, Linear Algebra and its Applications, 4^{th} ed., Brooks Cole, Florence, K Y, 2005. Thus,

X=UΣV^{T}

where U and V are orthogonal matrices, and Σ is a diagonal matrix with non-negative elements arranged in descending order. The columns of V, being the principal component vectors, represent the coordinates or basis of the axes of the new frame of reference. The ratio of the square of each singular value to the total sum of squares of all the singular values represents the percentage to the total variation contributed by each principal component. A Scree plot can be developed to show the cumulative ratio of this measure.

Since the original data are assumed to be heavily correlated, and the singular values are arranged in descending order, one can make a decision as to how many principal components to keep in building the PCA model to represent the original data. The discarded data along the remaining principal components are regarded as less important and are ignored.

Each principal component may be of unit length and orthogonal to all other principal components. The principal components are the columns of the right singular matrix, V, of the singular value decomposition (SVD) of the data matrix, X, above. Each principal component is expressed as a linear combination of the original variables, with the entries of the principal component expressing that particular linear combination. The absolute values of all entries are less than or at most equal to 1. Therefore, those entries with relatively large values indicate that the corresponding original variables exert greater influence along this principal component's direction. The variables with correspondingly heavy weights are also the ones being correlated in the original data set.

If the columns of the data matrix, X, are not first mean centered, such that the mean of each treated column is zero, then the first principal component reflects the average values of the variables represented in the new principal component frame of reference. It is then the next few principal components that serve to differentiate between personal profiles, products, services, product providers, service providers and images. Therefore, mean centering is an optional step that provides no additional capability and is not performed here.

After the principal components are found, each data vector can be projected onto each principal component. The projected vector is referred to as the scores vector for each sample. The length of the scores vector indicates how closely aligned each sample of that data is to that principal component. The bigger the projection, the better the principal component represents the data vector. Thus, data vectors with comparable projections onto a principal component can be regarded as “similar” to each other, with respect to that principal component. Those data vectors with high projected values onto the principal component indicate that these data vectors are highly aligned with the principal component, therefore representing more of the original variables which are heavily weighted in that principal component. Similarly, projections of data vectors onto each of the succeeding principal components can be carried out to get the scores and their projections onto those principal components.

Because of the different degree of variation exhibited by the data vectors along the different principal components, normalization is necessary, such that normalized distances from the origin to each projected point can be meaningfully compared. The Mahalanobis distance measure is employed, in which each projection is divided by the corresponding singular value.

The Mahalanobis distance scores are calculated as follows:

Mahalanobis Scores=XVΣ⁻¹=U

where X represents the original data matrix, and U, Σ and V are from the SVD of X. Postmultiplying X by V performs the projection of the rows of X (DNA profiles) onto the principal components, with the projected vectors represented with respect to the principal component axes. Postmultiplying XV by Σ⁻¹ scales each column of XV by the inverses of the corresponding singular values contained in Σ. A two dimensional plot can be used to show the scores onto principal components i and j. In plotting the scores plot in, say PC2 and PC3, it is the row entries from the second and the third columns of the Mahalanobis scores matrix (the U matrix) that are plotted in a 2-d plot. Henceforth, the Mahalanobis scores shall simply be referred to as the scores.

An aspect is why certain principal component axes, taken for particular portions of the raw data, exhibit good clustering properties, while others may not. The answers lie in both the statistical properties of the data and the encoding method. Thus, fewer, and more distinct, clusters tend to be formed in profile, product and service data. The encoding also plays a role. For example, discrete variables that are numerically encoded tend to enforce a more distinct separation between clusters.

Distinct clusters can be established analytically by the k-means clustering algorithm, which typically works well for naturally occurring data. Other clustering algorithms known in the literature may be used. Clusters identified by k-means may be validated by for the personal profile database. Memberships within each cluster were analyzed to determine the similarity among the members. Clustering may center typically among members of a family or household with respect to personal profile data and documents associated with one household member of a client computer may be shared by other members of the household. Examples may be joint use of credit cards, bank accounts, products, services and historical data.

John or Joe and Tom but not Mary may use the product X or the service Y. John and Mary may share the same Visa credit card or bank account. Boolean expressions can be rewritten in various forms and simplified according to methods that are well known from the fields of Boolean algebra and logic circuit design.

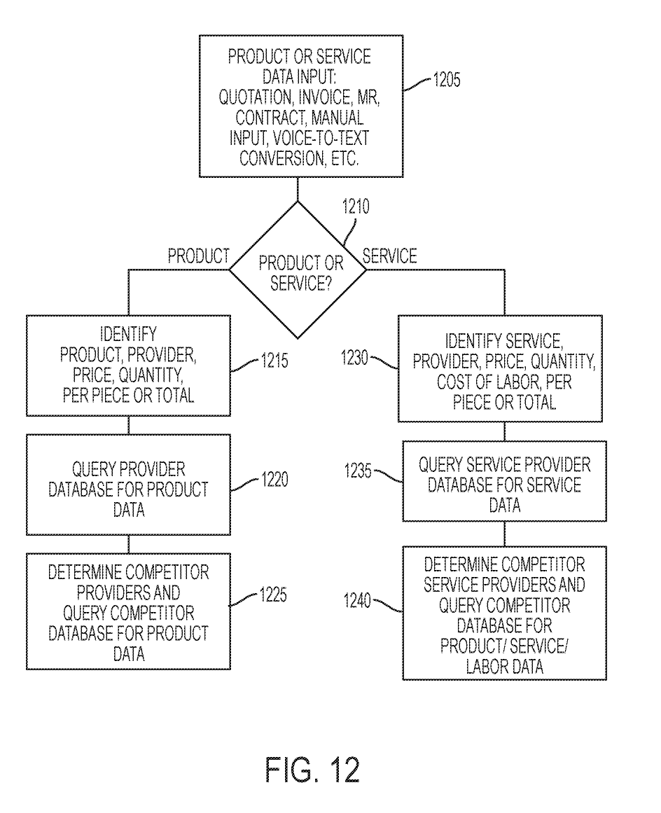

The Boolean expressions that describe each cluster form a test that can be applied to any data record in any database. These tests can be utilized to form a decision tree that sequentially applies tests to assign the record to a cluster, and therefore to a descent path through the database index, using the methods of inductive inference that were pioneered by J. Ross Quinlan; see, for example, “Induction of decision trees,” Machine Learning 1:81-106, 1986. In this case, each node of the database tree that utilizes clusters derived from the multivariate statistical analysis method would contain a decision tree specifying the sequence of tests to be applied to personal profile, product, service and other targets at that node, and the database tree can be rewritten by expanding these nodes and incorporating the decision tree's nodes into the database tree. A graphical depiction of the database index that results is shown in FIG. 12. FIG. 12 is a graphical depiction of a database index dynamically constructed from the results of multivariate statistical analysis, combined with a ranking strategy based upon a measure of similarity between objects, to address the needs of various error resolution applications according to at least one embodiment of the invention.

### Content-Based Image Recognition (CBIR)

Automated identification of objects such as identities of individuals, products or services using image analysis requires isolation of image segments corresponding to each object and comparison of each segment's data against a reference database to identify stored image segments with similar properties. An object vector can be used to search for similar reference objects in an image database, and metadata (properties) associated with the search results can be utilized in conjunction with a database Model to predict a geographic location of the image (one's home), or characteristics of the location, that is likely to be associated with the target sample. This subsection provides an overview of content-based image search and retrieval, and of preferential image segmentation based upon a tree-structured decomposition and representation of an image called the “tree of shapes”.

Traditional image search methods are based on keywords. The keywords are chosen in a way that best represents image content, which requires expert knowledge and is labor intensive. An automated content-based image search capability can be more effective and practical when it is feasible. Similarity-based search strategies that find images that are similar to a target using specified similarity criteria are typical of content-based methods. One approach is to embed data objects derived from the images in spaces such as metric spaces and use the distance function or metric as an inverse measure of similarity. Images are represented as points in the metric space, and the image indexing and retrieval method may rely upon properties of the triangle inequality if the distance function is a metric. Performance is a function of several design decisions, such as the selected image preprocessing algorithms, as well as the index structure and the methods used for data retrieval. The purpose of image preprocessing is to extract a vector of desired features from the original images. The research efforts at the University of Tennessee have utilized multivariate statistical analysis based upon PCA to extract feature vectors from images. The feature vectors are embedded in the space, which in this example is a metric space, and are stored in an index structure that is optimized for similarity search. When a search query arrives, similarity search strategies based on the triangle inequality are used to retrieve the images that satisfy the search criterion.

Similarity search based on metric spaces was first introduced in Burkhard, (W. A. Burkhard and R. M. Keller, “Some approaches to best-match file searching,” Comm. ACM, 16 (4) 1973, 230-236). The triangle inequality was first used for similarity search by Koontz, (W. L. G. Koontz, P. M. Narendra, and K. Fukunaga, “A branch and bound clustering algorithm,” IEEE Trans. Comp., C 24, 1975, 908-915). Algorithms based upon this approach can be divided into two categories according to the way in which they partition the metric space. Some partition the space using reference points, while others achieve that based on Voronoi partitions, (F. Aurenhammer, “Voronoi diagrams: a survey of a fundamental geometric data structure,” ACM Comp. Surveys (CSUR), 23 (3) 1991, 345-405). This portion of prior research has focused on approaches based on reference points. In these approaches, several points in the metric space are chosen, and the distances between these points and all the remaining points are calculated. The metric space is then partitioned according to these distances. For example, Yianilos implemented vp-tree using this idea; see, for example, P. Yianilos, “Data structures and algorithms for nearest neighbor search in general metric spaces,” Proc. of the 4^{th} Annual ACM-SIAM Symp. On Discrete Algorithms, Austin, Tex., 311-321, 1993. In the literature, the number of metric computations is typically cited as the criterion of performance. However, this is not a good indicator of performance when preprocessing steps are utilized and the metric is applied to a feature vector. Image preprocessing is a critical component of similarity search strategies that has a significant impact upon overall performance. Search accuracy is also a very important aspect of performance, and must often be judged subjectively using human evaluation. The critical issue is whether searches return results that are useful to the end users, and the choices of metric space and preprocessing steps both influence subjective search accuracy. New performance criteria that consider both search efficiency and utility have been utilized in our prior research to guide the development of CBIR databases; see, for example, Z. Shen, Database Similarity Search in Metric Spaces: Limitations and Opportunities. M. S. Thesis, University of Tennessee, August, 2004.

CBIR database design using a metric space approach may be initiated with a choice of preprocessing to extract feature vectors from images, and of the metric space. Let X be an arbitrary set. A function d:X×X→ [symbol] is a metric on X if the following conditions are satisfied for all x,y,z∈X:

Positivity: d(x,y)>0 if x≠y, and d(x,x)=0

Symmetry: d(x,y)=d(y,x)

Triangle inequality: d(x,z)≤d(x,y)+d(y,z)

A metric space is a set with a metric, (X,d). Elements of X are called points of the metric space, and d(x,y) is the distance between points x and y.

Image similarity search approaches based on metric spaces embed all images in a metric space. Similarities between images are evaluated quantitatively by the metric. Similarity searches are modeled by range queries in the metric space, such as: “Find all images within a certain metric value, or distance, from a specified target.” Given query (q,r) on a data set in a metric space U, where q is the search target and r is the search range, the goal is to find all objects that are within distance r from the point q in the metric space, or the set {uᵢ ∈U|d(q,uᵢ)≤r}, which is called the result set of query (q,r).

Search methods based on metric spaces can use tree-structured indexing techniques to achieve a sub-linear time complexity. At each tree node, indexing divides the data set into several subsets based on similarity relations between objects. Indexing based on a metric space is equivalent to hierarchically partitioning the space into several subsets. Different partition strategies yield different search performance. All the existing partition strategies can be divided into two categories: methods using reference points, and methods based on Voronoi partitions. The prior work at the University of Tennessee focused on approaches based on reference points. Partitioning approaches using reference points choose several reference points in the space and assign one or more of them to each node of an indexing tree. The set of images associated with a node is divided into several subsets according to the distances between the images and the reference points. Child nodes repeat this process with other reference points until leaves in the index tree are reached. In this manner, the space of images is hierarchically partitioned into portions of annular regions.

Given the desired tree height h, h reference points {p₁, p₂, . . . , pₕ} are chosen. A reference point pᵢ is assigned to the nodes at level i of the tree. At level i, the space is partitioned into several non-intersecting annular regions Rᵢⱼ, j=1,nᵢ centered at the reference point pᵢ, defined by a sequence of increasing diameters. Given the set of data points U embedded in the metric space, the annular regions associated with reference point pᵢ are

Rᵢⱼ={uₖ∈U|d(uₖ,pᵢ)∈[aᵢⱼ,aᵢⱼ₊₁]}

where {aᵢⱼ}ⱼ₌₁ⁿ^{ᵢ}⁺¹, is an increasing sequence with aᵢ₁=0 and aᵢₙ_{ₜ}₊₁=00. The indexing tree can be visualized as h levels of annular regions that overlap. The final partition consists of the intersections of all the annular regions. CBIR may be used with bar codes, product images, service images, client user images (for example, for verification) and document images (JPEG) and with videos (collections of sequential images).

FIGS. 6A, 6B and 6C illustrates an example of the partition of a 2-level indexing tree. In FIG. 6(A), the space at tree level 1 is partitioned into three annular regions R₁₁, R₁₂, and R₁₃ (with a fourth region implicitly extending from the largest boundary shown in the figure to infinity, which is generally empty). At tree level 2 in FIG. 6(B), the space is partitioned into two annular regions R₂₁ and R₂₂. The final partition FIG. 6(C) of the 2-level indexing tree is produced by the intersections of these five annular regions. There are eight subsets in the final partition FIG. 6(C) (not including the implicit regions that extend to infinity).

Image similarity search methods that use indices based upon reference points may use the triangle inequality to rule out partitions, and therefore paths of descent in the index tree, that cannot contain a solution. The search request propagates through the tree-structured index, and a candidate set is generated. A result set, which is a subset of the candidate set, is obtained by exhaustively searching the candidate set. The candidate set of query (q,r) is found using the triangle inequality.

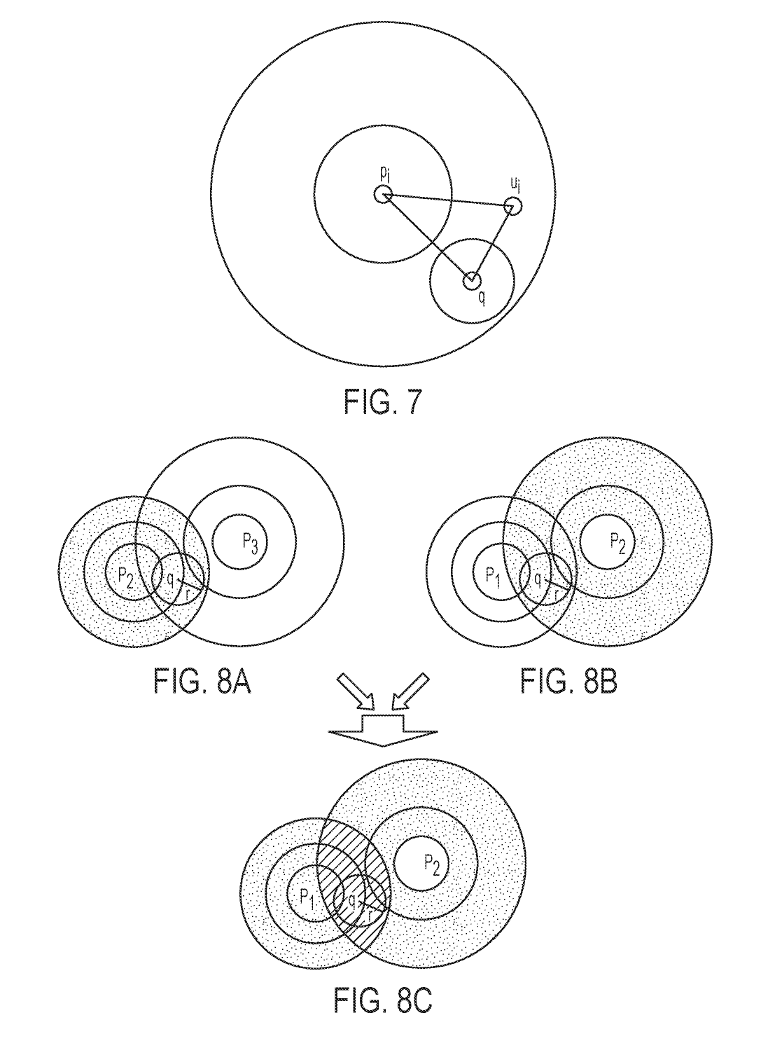

FIG. 7 shows the triangle inequality. In FIG. 7, three points, a reference point pⱼ, the query target q, and an object u, are located in the metric space, demonstrating the triangle inequality in similarity search. The triangle inequality relates the values of the metrics, or distances, as represented in the figure by lines, by the inequalities:

d(q,uᵢ)≤d(uᵢ,pⱼ)+d(q,pⱼ)

and

d(q,pᵢ)≤d(uᵢ,pᵢ)+d(q,uᵢ)⇒d(q,pⱼ)−d(uᵢ,pⱼ)≤d(q,uᵢ),

or

d(q,pⱼ)−d(uᵢ,pⱼ)≤d(q,uᵢ)≤d(q,pⱼ)+d(uᵢ,pⱼ).

If uᵢ belongs to the result set, it should satisfy the search criterion

d(q,uᵢ)≤r,

or

d(q,pⱼ)−r≤d(uᵢ,pⱼ)≤d(q,pⱼ)+r.

Therefore, a necessary condition SC that must hold in order for the search criterion to be satisfied by uᵢ is,

$$SC = {⋂}_{j = 1}^{k} \{ {u}_{i} ∈ U \vert d ( {u}_{i} , {p}_{j} ) ∈ [ d ( q , {p}_{j} ) - r , d ( q , {p}_{j} ) + r ] \}$$

The candidate set Cand is the union of all the stored objects lying within partitions that intersect the search criterion SC,

$$Cand = {⋃}_{i = 1}^{t} \{ {P}_{i} \vert {P}_{i} ⋂ SC \neq ∅ \}$$

where t is the total number of partitions. Once the search request has been restricted to the candidate set, the candidate set is scanned exhaustively to get the result set,

Res={uᵢ∈U|uᵢ∈CandΛd(uᵢ,q)≤r}

FIGS. 8A, 8B and 8C illustrates an example of processing a search query (q,r) on a two level index tree based upon reference points P₁, P₂, P₃. In FIG. 8(A), three subsets intersect with the search criterion, and in (B) two subsets intersect with the search criterion. The shaded area in FIG. 8(C), which is the intersection of the two shaded areas in FIGS. 8(A) and 8(B), represents the candidate set of similar objects (family profile data, products, competitive products, services, competitive services and images among other databases).

One component of the search time is typically proportional to the size of the candidate set, due to linear search. A second component is due to traversal of the tree, and is typically logarithmic in the size of the database, and a third component is due to computation of the metric distance from the query to each reference point. This is summarized by the equation

T=N_{ref}×T_{metric}+N_{cand}×T_{metric}+Tₜᵣₑₑ=(N_{ref}+N_{cand})×T_{metric}+Tₜᵣₑₑ

where N_{ref} is the number of reference points, N_{cand} is the number of objects in the candidate set, and Tₜᵣₑₑ is the tree traversal time. Let N_{metric}=N_{ref}+N_{cand}, which is the total number of metric evaluations. Since metric computations are usually more time consuming than the time required to traverse the index tree, Tₜᵣₑₑ can be neglected. In most situations, N_{cand}>N_{ref} by a wide margin, so the size of candidate set is the dominant component and the search time is primarily determined by N_{cand}.

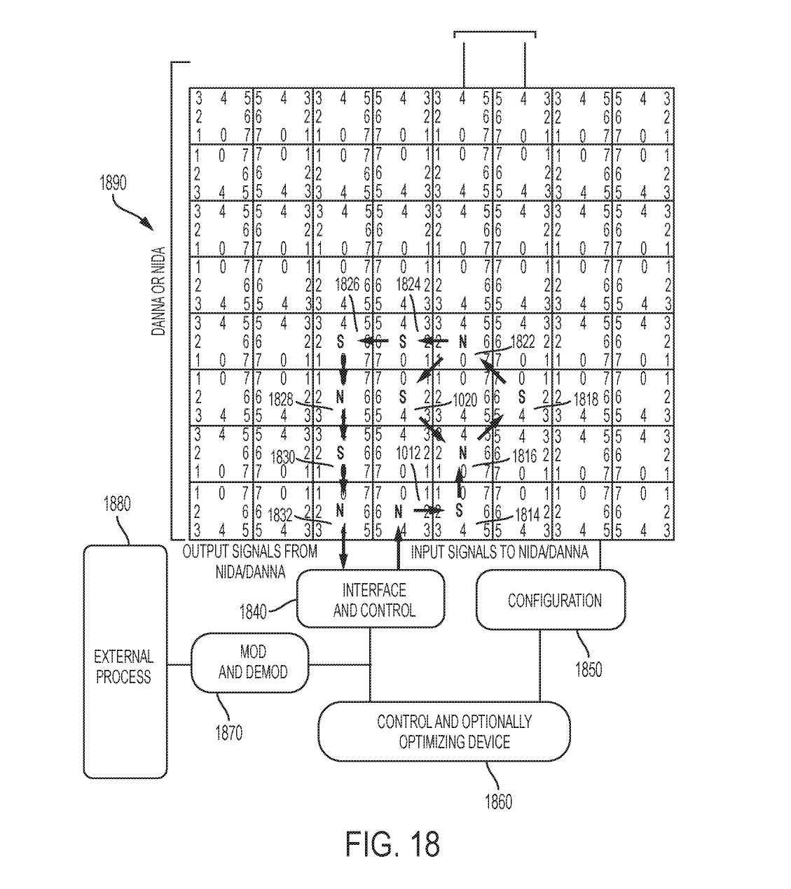

The design of a CBIR database for images, for example, of products or competitive products or the results of services or competitive services is typically an iterative process, with trade-off studies performed on a sample of representative images to determine the optimal preprocessing strategy and embedding in a metric space. This process needs to be guided by quantitative evaluations of the performance of candidate designs. Usually, the number of metric computations determined by the candidate set size is used as the criterion to evaluate search performance. However, this criterion only works for comparing different search methods that produce the same result set. In other words, the comparison of N_{metric} is feasible when the search results are the same. Different image preprocessing methods, index structures and retrieval strategies will yield different result sets. Therefore, a new criterion that considers both the candidate set size and result set size is required. The ratio between Nᵣₑₛ, the number of results of a search, and N_{cand} has been chosen to meet this requirement. A high quality search strategy should yield a large value for the ratio Nᵣₑₛ/N_{cand}. In other words, Nᵣₑₛ should be close to N_{cand}, which means few unnecessary metric computations are performed during the search. The value of Nᵣₑₛ/N_{cand} also measures the efficiency of a search strategy. In order to compare the performance across different data sets, normalized search ranges are used. A normalized search range is the ratio between the search range and the average distance between all the stored objects, or r/μ, where the average distance μ is

$$μ = \frac{{\sum }_{i = 1}^{{N}_{total}} {\sum }_{j = i + 1}^{{N}_{total}} d ( {u}_{i} , {u}_{j} )}{{N}_{total} \times ( {N}_{total} - 1 ) \text{/} 2}$$

where Nₜₒₜₐₗ is the total number of objects stored in the database. A figure that illustrates the values of Nᵣₑₛ/N_{cand} against different r_{normalized} is used to evaluate the performance of different metrics and data extraction methods. In such a figure, the area under the curve of Nᵣₑₛ/N_{cand} indicates the performance, and a larger area means a better performance with respect to search efficiency. FIG. 18 is an example figure comparing performance of two different data extraction methods a and b.

The area under curve a is larger than that under curve b. Thus, the search performance of using data extraction method a is better than that using b. In order to make this criterion more suitable for practical applications, an improved performance evaluation method is provided. Assume the search ranges are distributed exponentially, i.e.,

p(r_{normalized})=γe^{-γr}^{_{normalized}}

for a positive constant γ. The search performance for search ranges smaller than rₘₐₓ can be evaluated by a weighted integration,

$$φ ( {r}_{max} ) = {\int }_{0}^{{r}_{max}} \frac{{N}_{res} ( \hat{r} )}{{N}_{cand} ( \hat{r} )} γ {e}^{- γ \hat{r}} d \hat{r}$$

The performance characteristic measured by ϕ(rₘₐₓ) is expected search efficiency over exponentially distributed search ranges less than rₘₐₓ. The value of rₘₐₓ is assumed to be sufficiently large that the contribution by the tail of the distribution can be neglected.

The numeric value of ϕ(rₘₐₓ) provides a method of comparing search efficiency across candidate database designs. Another critical measure of performance, which tends to be highly subjective, is the utility of search results. In other words, the search method may return results that are useful to users.

A CBIR database may be used to store raw images, but it is likely to be more effective in the identification of particular products or competitor products if the images are first segmented. An ideal segmentation would create images containing, for example, individual products (bar codes or SKU identification), individual (fingerprint or facial recognition) or competitor products with no background or obscuring data. This can be done manually, but partial or total automation of the image segmentation step may use a preferential image segmentation algorithm based upon “tree of shapes” descriptions of the image and image segments, as described in detail in Y. Pan, Image Segmentation using PDE, Variational, Morphological and Probabilistic Methods, PhD Dissertation, Electrical Engineering, University of Tennessee, December, 2007, incorporated by reference in its entirety. This representation provides a hierarchical tree for the objects contained in the level sets of the image. The hierarchical structure is utilized to select the candidate objects from the image. The boundaries of the selected objects are then compared with those of objects selected from prior images. By means of the tree of shapes and curve matching, the proposed method is able to preferentially segment objects with closed boundaries from complicated images. It is more straightforward to utilize prior information in this way than with curve evolution methods, and there is no initialization problem. Furthermore, the method is invariant to contrast change and translation, rotation and scale. The method has been shown to work in the presence of noise.

The preferential image segmentation algorithm is illustrated by example. An intuitive description of the algorithm is to construct the trees of shapes for both a target and a candidate image that are to be compared. The candidate image would correspond to a reference image of a pollen grain in a database, while the target image would correspond to a sample to be analyzed. Both images are segmented into a tree of shapes description, which is a nested collection of upper (or lower) level sets; see, for example, L. Ambrosio, V. Caselles, S. Masnou, and J. M. Morel, “Connected components of sets of finite perimeter and applications to image processing,” Journal of the European Mathematical Society, 3(1):213-266, 2001. The objective is to find a node within the tree of shapes description of the candidate image that is the root of a sub-tree that matches the tree representation of the target (reference) image to within a specified accuracy.

In one embodiment, preferential image segmentation may be utilized to isolate images of individual products or products competitive with or similar to the individual product for identification. Feature vectors are extracted from each isolated image and utilized to query a database of reference images and associated metadata in order to select the most similar reference data to each product from the database and identify the product or competitor product with some likelihood of identification. Product data can be constructed for each sample product from these identifications, substantially reducing the human labor necessary to process samples.

Past automated identification efforts have relied upon image analysis algorithms that are specific to shape or textural features, or artificial neural networks (ANN). Of the ANN approaches, France et al. (I. France, A. W. G. Duller and G. A. T. Duller, Software Aspects of Automated Recognition of Particles; the Example of Pollen, Image Analysis, Sediments and Paleoenvironments, P. Frances (ed.), Kluwer (2004) 253-272) appear the most promising. France et al. utilize a 3-layer network, using Gabor filters to detect edges, followed by a layer to piece edges together into an object and a final layer for identification. During training, their approach adds new objects that cannot be classified to the set of classes, allowing the algorithm to adapt to newly presented data (if done in training).

CBIR using similarity search is applied in one embodiment for product recognition, individual user recognition and service recognition allowing Model-based prediction of, for example, a product's identity using the most similar reference data available. This approach provides a natural growth path as new data are added to the reference collection, obviating the need for new algorithms or retraining of classifiers. A product photograph obtained from Amazon may or may not be the same two dimensional image of the same product obtained from a Bloomingdale's catalog or web site. The objective is classification of each product and subsequent calculation of one or more competitive products for each sample product, using a system and methodology that can grow with the reference collection, producing better predictions with greater accuracy over time.

Thus, there is provided an automated analysis and identification of products (for example, starting with an NFC tag or bar code), competitive products, individual users for user profile data, larger/smaller objects in size such as a larger and smaller image of competitive products and the like which may be found in trace quantities of or even be the target object. For example, the actual image may have to be compared with available size data in order to determine which of a product and a competitive product is larger or smaller in size. Content-based image retrieval (CBIR), and associated databases which may contain photographs, X-rays, Mill image data, infrared image data and the like, is a relatively new technology that has undergone rapid evolution over the past decade. The literature on automated identification focuses primarily on two approaches: structural/statistical techniques, and methods based upon neural network classifiers. The first approach requires image analysis algorithms tailored to resolve specific features, while neural network methods have difficulty extending as the reference data expand, without lengthy retraining. CBIR, combined with preferential image segmentation, will be effective in reducing the burden placed upon the classification step by focusing the classifier's scope to the set of reference data and features (for example, apertures and sculpturing on pollen grains) most similar to a target sample's image(s) and most likely to lead to accurate identification.

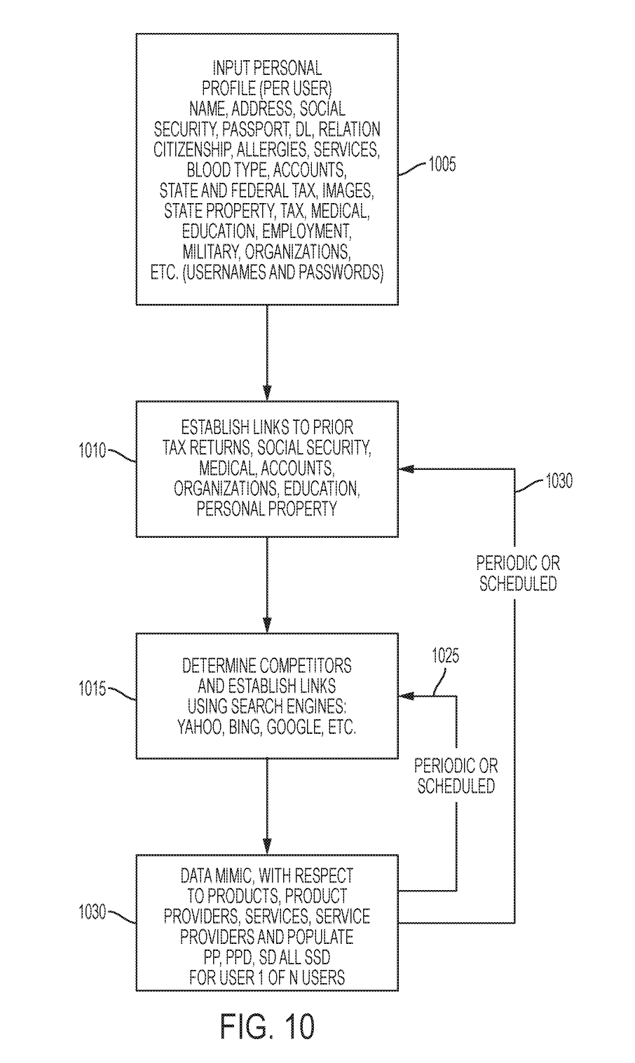

Referring now to FIG. 10, the steps of establishing a user profile will now be described for a given user of the present error resolution system. Step 1005 is directed to inputting a personal profile of an individual user. An individual user of a system of the present invention may be identified by full name, address, social security number, passport number, driver's license, relationship to other members of a household using the same client (such as husband, wife, oldest female child), birth date, citizenship, allergies, services used, products used, blood type, medical records links, bank, investment (assets such as securities and cash) and credit/debit card accounts, internet site accounts (Amazon and Ebay, for example), state and federal tax return links (for example, Turbotax), personal images by date and location, state property tax (personal and real), educational background and diplomas/degrees received, employment history, military history, organizations joined, dues, committee or sub-organizations and dates, and user names and passwords (among other personally chosen data) to obtain access to related web sites.

In step 1010, the system of the present invention proceeds with the establishment of links to documents stored on the client and outside the client on related databases or in NFC tags which may comprise links to tax returns, social security statements, medical records internal and external to the client, account data internal and external to the client, organizational data internal and external to the client (for example, does the individual have a paid-up subscription to Angie's List to obtain competitive service provider data), and personal property holdings and dates and prices of acquisition (vehicles, art work, collectibles, antiques, products including appliances and the like). In order to obtain further information, the user names and passwords (among other personally chosen data) are used to obtain access to related web sites to obtain data periodically or on a specific schedule for local storage in the PD, PPD, SD and SPD as well as image databases.

In step 1015, the process of profile development determines competitors and establishes links for communication using search engines such as Yahoo, Bing and Google or particular links such as bank account, investment account, dental record, medical record and service related links of products and services used as well as competitive products and services.

In step 1020, data mining is performed with respect to products, product providers, services and service providers and the PD, PPD, SD and SSD as well as image databases are populated with product and service and competitor data. Step 1020 is connected to 1015 by a link 1025 for periodically or on a particular schedule repeating step 1015 to obtain more recent data. Similarly, step 1020 is connected to 1010 by a link 1030 for periodically or on a particular schedule repeating step 1010 to obtain more recent data. Changes in packaging or product identity may be recognized by content based image recognition. To determine if the product is the same as one previously retrieved from historical data, the product features, size, shape and the like must be compared. For example, bank account data may change at least monthly because interest may be accrued or monthly fees may be charged on that interval, but to determine if a particular check has been cashed, the bank account may have to be checked daily.

### Error Resolution Overview

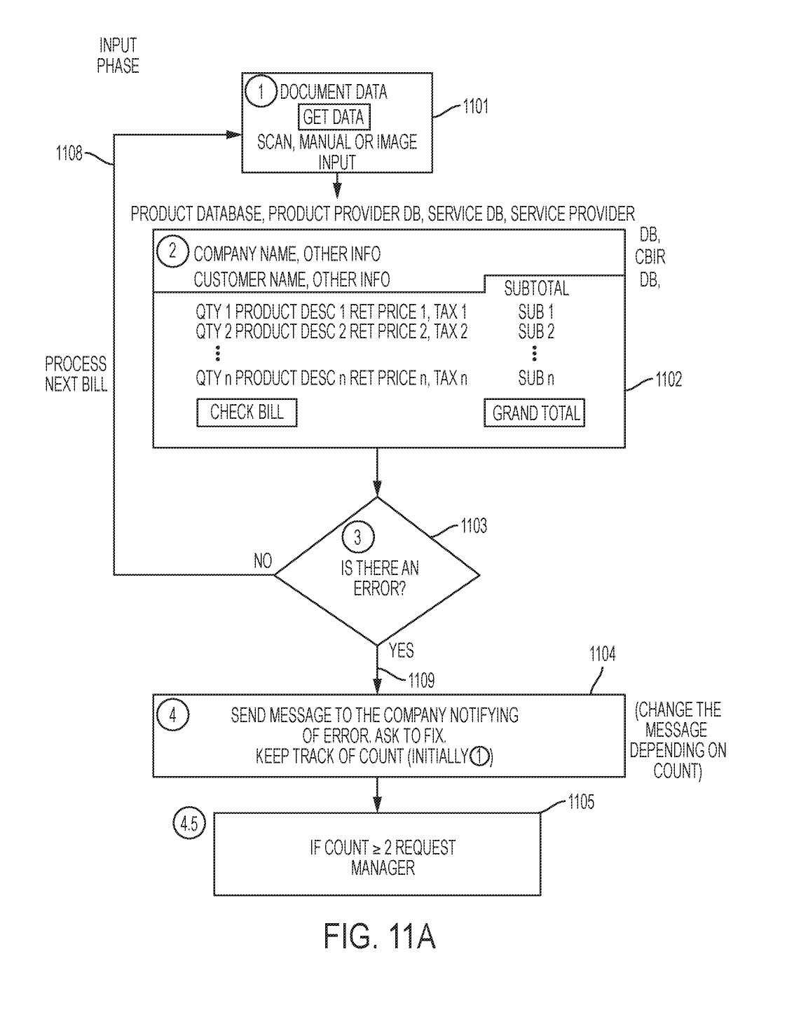

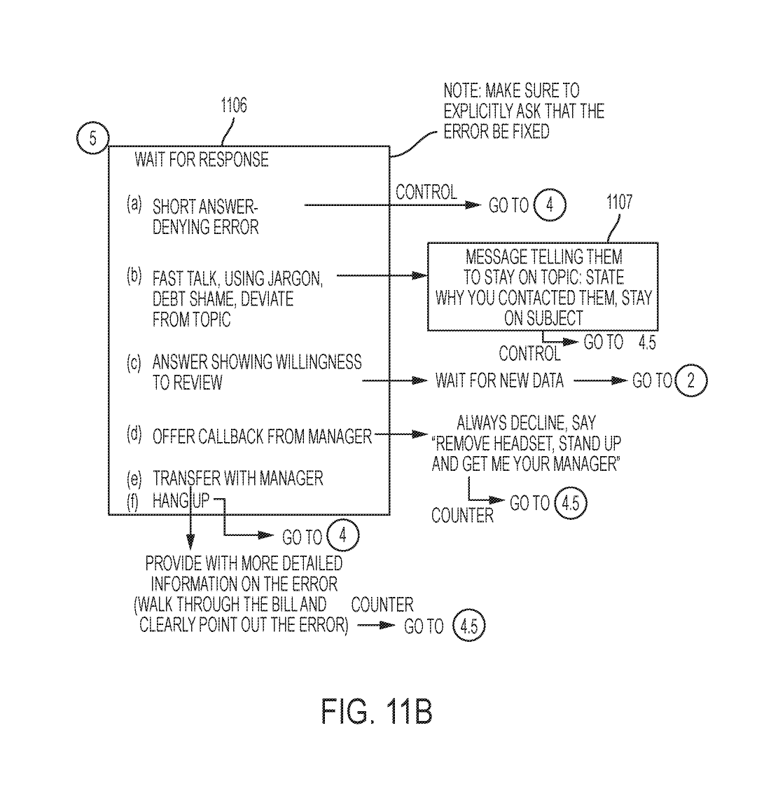

Now an overview of the error discovery and resolution process of the present invention will be described with reference to FIGS. 11A and 11B where FIG. 11B is a continuation of the process of FIG. 11A. Let's assume that a customer goes to a large, nation-wide department store to shop and places food and clothing in a shopping cart. The shopper may use their intelligent NFC device or camera to collect and scan bar code or NFC tag or other product identification data available to it. Also, GPS may provide an input to the intelligent device, Google or Yahoo Maps referred to if necessary, to identify that the large department is located in the Philadelphia, Pa. area. In Philadelphia, Pa., for example, food is not taxed and clothing is in the location of the large department store where the items are purchased. This diagram, at least, FIG. 11A will be described as an Input Phase where the first step 1, 1101, is the input of document data which may include NFC tag data, bar code data, SKU tag data or other data available where the shopper finds the item that the shopper wishes to consider purchasing. The document may, for example, be an NFC transaction about to occur, a statement just received from American Express, an invoice of a first large department store, an invoice from a second large department store, an estimate or contract for plumbing services including a bill of material, an estimate for a landscaping project, an invoice from a first telecommunications service provider who may also offer cable television services, a receipt for repair services performed on one's automobile including a bill of material and the like. The pre-sale or sale data may be entered by scanning and saving as a pdf. The pdf may be converted to text or numerical data by known software such as is available from Adobe. Images may be gathered and stored associated with the input document parsed and identified using CBIR. Indeed, another means of data input is by camera, RFID-like tag, bar code or other coding and storage of JPEG files. Also, data may be manually input by the user (the most tedious way). The data extracted from various data acquisition devices such as NFC tag readers, cameras, bar code readers and the like may be stored therefrom by known parsing software in respective product or service or product provider or service provider databases. An example of a product, product provider, service, service provider, image or personal profile database is shown as step 2, 1102. The database may include, among other data fields, company name (a first large, nation-wide department store), date, address (for example, determined by GPS and mapping), customer name, address, quantity, product, description, price, tax, subtotal, grand total and the like with the error resolution software checking at least the mathematical calculations to be made on a prospective or actual invoice and their validity. The process does not end with simple mathematical calculations checking. For example, the sales and use tax figure may be calculated based on the incorrect jurisdiction or be collected in error because the particular item should not be taxed in the tax jurisdiction of the location of the purchase. The state of Pennsylvania may declare a free sales tax day to compete with tax-free Delaware. Consequently, to properly act upon and discover an error in a given document, the document (including an NFC tag or bar code) must be examined as a whole for errors. A model may be used to predict the consequences of a discovered error such as the periodic taxing of an item that is periodically bought at the first large department store according to historical data and a projection of the cost of the error made.

Still referring to FIG. 11A, step 3, 1103 asks whether there is an error in the document input at step 1101 and analyzed at step 1102. As can be seen, the answer is not so easy because a number of resources may be required to determine whether, for example, an error in the application of sales and use tax for the particular itemized products may occur during transaction processing. One error that may occur is incorrect identification of a product taken from a shelf where the product may not be associated with an NFC tag or bar code (for example, the product on the shelf needs to match the tag). The error may be applicable to one product purchased and not another (clothing versus food, for example) for example, a sales tax error. The error discovery and resolution system of the present invention may require access to state and local taxation regulations which may vary on a particular day (such as a Pennsylvania declared tax-free day). The client/server system must be able to verify that a particular category of goods such as clothing is taxed in the jurisdiction of the specific location of the first large department store and that, in fact, clothing was bought and delivered to the user and at what tax rate was it taxed and according to what tax jurisdiction. Use tax is applicable to goods shipped from one state to another as a tax on the use of the goods and not necessarily the purchase (such as an internet purchase). If the answer is no error has been found, then, at step 1103, the process returns via process next document path 1108 to data input 1101. But, if an error has been found or is about to occur when the transaction terminal processes a sale, then, via path 1109, an error message or communication step 4, 1104 is initiated. According to one embodiment, the company name (the first large department store in Philadelphia, Pa. area) identified in step 1102 is located on the web, via GPS or other communications means and a communication or message is generated at step 4, 1104, identifying the transaction of step 2, 1102, and the prospective or actual error and why there is an error with a request, for example, for a fix, such as credit on a charge card or store credit and the like for a calculated correct amount of an error during, for example, an NFC transaction terminal process. In this step, 1104, the system may maintain a count of the communications, initially set at 0 for this transaction or document. (At step 4.5, 1105), the communication is escalated to a next higher level of communication within the company making the error when the count is greater than or equal to 2—for example, request the NFC transaction terminal to be sure of its application of a particular tax rate. This number of attempts to resolve at the transaction terminal or after the transaction is completed may be three or other number which may be set by the user to a number greater than 2 such as 3 (3 strikes and you are out philospophy).

Referring now to FIG. 11B, there is shown an example of a resolution process at step 5, 1106, where waiting for a response for a reasonable period of time, for example, two seconds for an NFC transaction terminal or one day for an e-mail reply, is attempted if an immediate response from company (the first large department store chain in the Philadelphia, Pa. tax jurisdiction) is not forthcoming. When the response is received, it may be in several categories. In (a), the department store response is denial and in our example of a sales tax that is applied erroneously to a particular product, the system returns to step 4, 1104 and tries again and the count of attempts to resolve moves from 0 to 1, from 1 to 2 and so on until the number of attempts at this level of communication can be believed to have failed. In (b), a number of scenarios are described which are similar to the short denial (a), fast talk, no answer, use of jargon (an attempt to scramble the law of sales and use tax in the jurisdiction), debt shame, deviate from the error or issue to be resolved (no answer). In b, step 1107 suggests a follow-on communication depending on the theme of the response in (b), for example, please stay on the topic of sales and use tax applicable to clothing in your jurisdiction, restate the error and the authorities behind the sales and use tax position taken, generally attempting to keep the offending company (the department store) or its transaction terminal or sales person on topic. The following are examples of automated systems besides an NFC or bar code system at the store that may be found on the internet and used for the purpose, eBay dispute resolution, chat lines, “contact us” e-mails at the department store web site and the like. An embodiment of the present invention will generate and transmit a communication via any of these automatically to seek resolution of a discovered document error that is determined within a reasonable certainty to have occurred. In this example of clothing not being taxed, there may be a degree of uncertainty that the item or product purchased is not classifiable as clothing. Consequently, the system may require artificial intelligence and modeling of the transaction and predictability of an error to determine what the company may respond is true or false. In (c), the system of the present invention may receive or demonstrate a willingness to review the error by double checking its sources. The system may return to step 2, 1102, to review the item in question, for example, to determine if the item in question is truly classified as clothing, may refer to its sources, for example, via a cloud-based server to determine if the sources of the sales tax data is accurate, or verify GPS data and location data to be sure that the department store location is indeed in Philadelphia, Pa. Or the product provider company (such as the large department store) may express a similar willingness to reconsider the transaction and admit that an error has been made. So the client/server system may wait a reasonable period for the company (large department store) to consider the transaction. In (d), company may offer a callback from the manager. In this situation, it may be appropriate (for example, if using a chat line) for the system to send a communication equivalent to “please remove your headset, and ask the manager to respond to my query.” If the manager is involved at (e), the system may provide further information to authenticate the error found (for example, take the manager item by item through the invoice communicating, for example, with synthesized voice that large department store appropriately applied tax here in your jurisdiction to clothing but this next item is food, which is not taxed.

### Product or Service Provider Input

Referring to FIG. 12, there is shown a platform for product or service data input in accordance with one embodiment. Product or service data may be input at step 1205 via NFC tag, bar code (caught by scanner or camera), SKU, camera image or other related identification data. The data may be in the form of a quotation, an invoice, a contract, manual input, voice-to-text conversion and parsing into fields of a database, and so on. At step, 1210, it is determined whether the input data refers to a product or to a service (or to both, since many services, such as automobile repair and plumbing involve a bill of materials which comprise items that may be classed as products). If a product, the product is stored in accordance with multiple dimensions and fields. Among these per step 1215, are product identity, product provider, price, quantity, per piece or with a quantity discount. Other fields may include sales tax applied, shipping and tax jurisdiction of the product provider. At step 1220, the system may automatically query the product manufacturer database or the product provider database for further information about the product. In addition, certain web sites exist which provide ratings for quality based on consumer reviews of a product such as Amazon.com.

At step 1225, the system may obtain product competitor data within the same or a different brand name or manufacturer/source. In this step, the system may identify competitive product using a cloud-based server, database and search engine and storing data in the cloud (with reference to FIG. 2) for multiple clients to share as a system resource.

If a service, the service is stored in accordance with multiple dimensions and fields. Among these per step 1230, are product identity (from a bill of material, NFC tag, bar code), product provider, service (category of labor), service provider name and address, price, quantity, per piece or with a quantity discount and duration of service (for example, hours on site for plumbing repair). Other fields may include sales tax applied, shipping and tax jurisdiction of the product provider. At step 1235, the system may automatically query the product manufacturer database or the product provider database or the service or service provider database for further information about the service. In addition, certain web sites exist which provide ratings for quality based on consumer reviews of a service such as Yelp or Angie's list (which can provide competitor information in a geographic area.)

At step 1240, the system may obtain product and service competitor data within the same or a different brand name or manufacturer/source or service (such as Sears versus another appliance repair service). In this step, the system may identify competitive services using a search engine and storing data in the cloud (with reference to FIG. 2) for multiple clients to share as a system resource (search for plumbers in Washington, D.C.) or search and obtain ratings using Yelp or Angie's list.

Product or Service Data Verification, localized errors

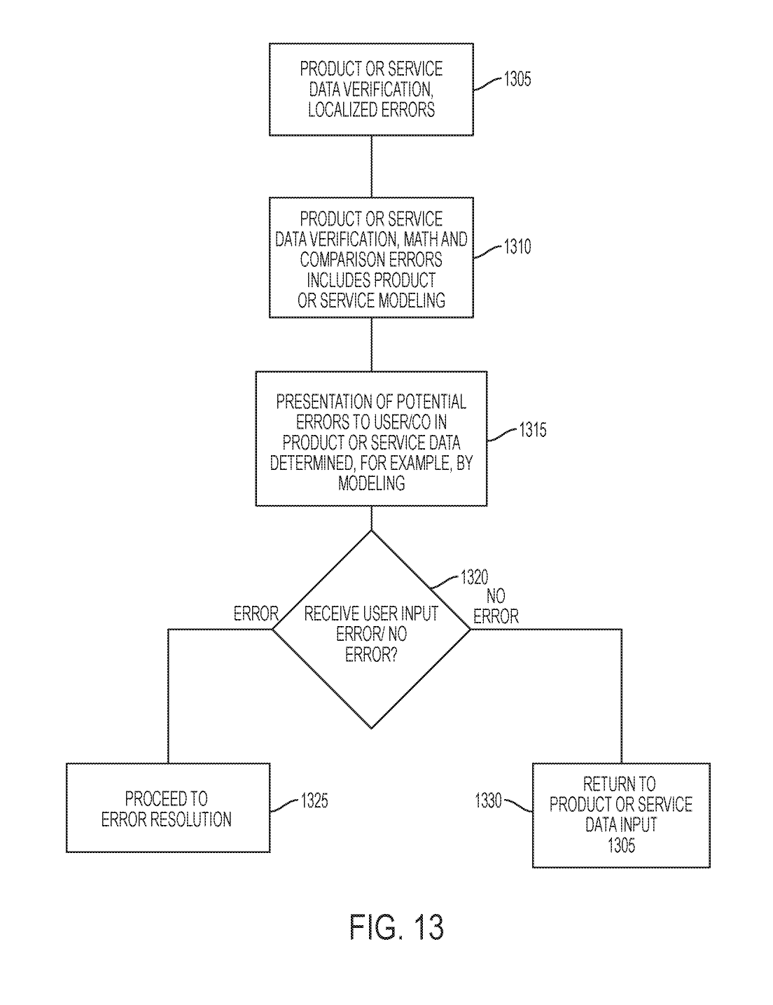

In FIG. 13, there is shown in similar detail the process of product or service data verification and/or authentication, step 1305, to identify localized errors, meaning using the client but potentially using a cloud-based server per FIG. 2 to obtain additional authentication data. At step 1310, product or service data verification begins. Mathematical calculation of quantity and price and tax per item as well as comparison errors are located which may include product or service modeling. For example, as discussed above, a shopper may go to the large department store and buy food and clothing and not be taxed at the appropriate rate for the tax jurisdiction on the particular day in which the large department store is located. A mere mathematical check will not uncover this error. On the other hand, the client may refer the calculation to a cloud server for referring to a state and local tax database or using a search engine to identify the tax that should be applied (or whether it should have been applied at all). Product or service modeling at step 1315 may be used with historical data of similar transactions to project exactly how much this type of error may cost the consumer over a period of purchases so that, if above a give threshold, the projected cost of the error in application of tax rates may be automatically be brought to the attention of the large department store in question for correction, preferably, automatically at the NFC transaction terminal level. At step 1320, the threshold test is applied and potentially user input sought to determine whether to proceed with resolution of an error or not attempt resolution at this time. If the error or errors are in excess of the threshold error (for example, 50 cents) and/or with or without the agreement of the consumer, the process either proceeds to error resolution at step 1325 or returns to product or service data input 1395 at step 1330.

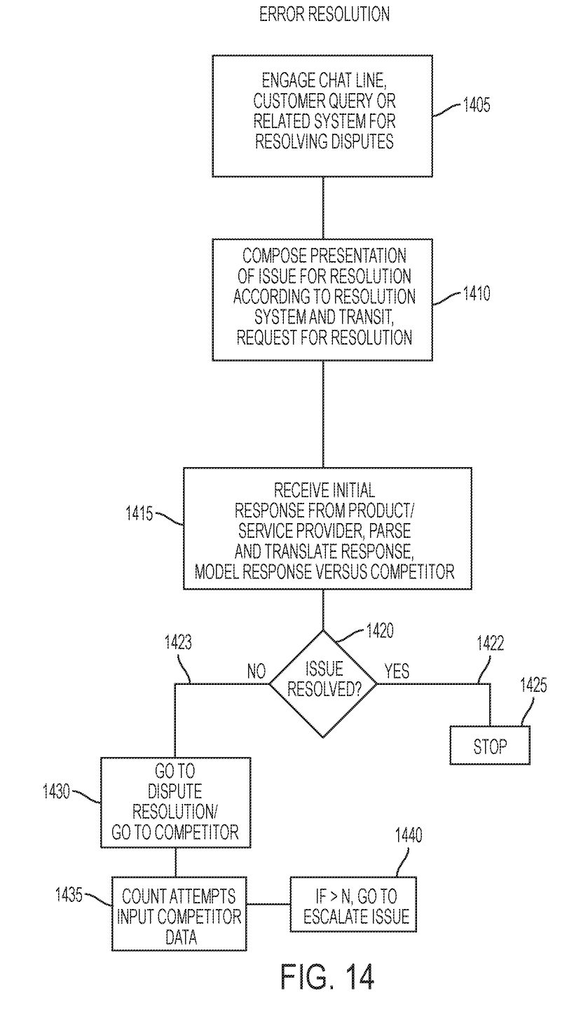

Referring now to FIG. 14, there is shown in similar detail the process of automatic error resolution. At step 1405, the system automatically engages in a communication link with the product or service provider to which an input document applies, for example, a large, nation-wide department store chain. It is expected that the present invention comprises, for example, an enhancement to NFC transaction conductions by near field two-way communication. A product of service provider may provide alternative ways of communication. Some firms provide a so-called chat line where typically there is depicted a service representative who is given a name and is allegedly a human interface with the product or service provider. In fact, the chat line may be an automated service that is only able to answer specific questions and must refer to a live representative once a more difficult situation is presented to the chat line. Some interne service providers such as eBay and Amazon provide a dispute resolution center portion of the web site which may be actively engaged in dispute resolution. For example, when a product shipped through eBay or Amazon is damaged in shipment or is lost in transit, the dispute resolution process typically provides a positive outcome for the consumer. There are service providers, on the other hand, which fail to provide useful web site or communications links such as Comcast, the telecommunications service provider with a reported poor service rating (at this time). The system may still generate and transmit an error resolution request to Comcast. Comcast provides through a communications link upon entry of an associated telephone number a cable set top box reset signal which can resolve service issues. At step 1410, the system composes and generates a presentation of an error in documentation or issue for resolution according to the present resolution system processes of using a cloud-based server per FIG. 2 to authenticate a given error such as an error in the application of sales tax to a specific item not taxable in the jurisdiction such as food by automatically structuring queries of state and local tax jurisdictions on a periodic basis. As suggested above, the entity may provide a chat line, a dispute resolution center or a simple e-mail to a customer service representative as a way to initially present an error for resolution. At step 1415, the system receives an initial response from a product or service provider. The system may be automatically linked to the chat line, dispute resolution center or otherwise scan incoming e-mails from the product or service provider for a response. In response to receipt, the system may parse the communication from the product and service provider in a known manner and automatically translate the response into a form to determine whether resolution of the issue or error is in process or not.

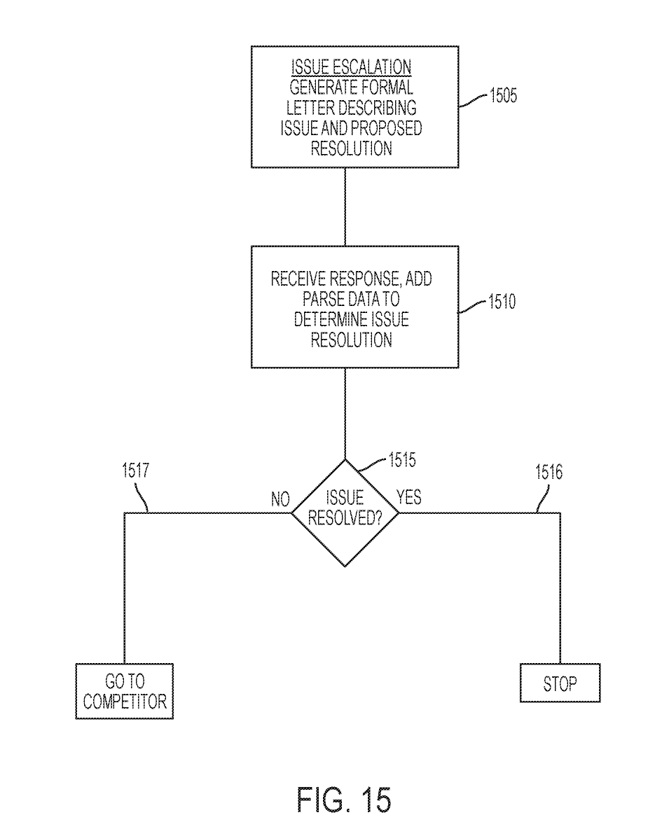

At step 1420, if the error or issue is not resolved, the system tries again at dispute resolution and at step 1435 count the attempts to resolve the dispute while responding to any requests by the product or service provider for additional information or back-up. For example, if the number of attempts is greater than or equal to 2 (or N) at step 1440, then the system may go to an escalate issue or error process of FIG. 15. If the error is resolved at step 1420, by path 1422, the process is satisfied and stops at step 1425.

The error/issue escalation process is shown in FIG. 15. At step 1505, the error in a document such as an invoice or related issue has reached an escalation stage from a chat line or first level of dispute resolution. The system may generate for transmission by mail or other communication to a higher authority in a given product or service entity such as a formal letter describing the document error or issue and a proposal for resolution. For example, in the department store, sales and use tax example of clothing and food, a copy of the invoice may be attached showing the sales tax applied and a discussion included of the local sales tax that should be applied under local jurisdictional law. The requested resolution may be a request for credit to be applied to a charge account or other account or a request for in-store credit. Between steps 1505 and 1510, the client processor awaits further input. At step 1510, a response is received and input at the client processor, the processor parses the received response and interprets whether the escalation stage has brought about a favorable income to the document error/issue which is asked at step 1515, Is the issue resolved? If Yes at 1516, the process may stop. If No at 1517, the client may approach a competitor for further products and services. In an alternative embodiment, the system client may try a third time, that is, a further escalation to the Office of the President by letter. In other words, the system may return to step 1505 and try one more letter to the highest authority in the product or service entity and await a response before suggesting the use of a competitor for future products or services.

### Product Exchange Example

A consumer buys an item of clothing at the Bloomingdale's store in New York, N.Y. and then goes home to Washington, D.C. The consumer is not satisfied with the size and takes the item to the Bloomindale's at Friendship Heights, Md. to exchange for a larger size. The NFC transaction terminal at Friendship Heights store refuses to credit the larger sales tax for New York against the Maryland 6% rate and so charges both the Maryland tax rate and the New York sales tax rate for the “simple exchange.” The present client/server system on input of the store receipt at the client end (per FIG. 2) historically recalls the New York store transaction and consults a cloud server for querying New York and Maryland sales tax rates to identify the problem and solution with particularity and generates a transmittal for resolution of the error requesting credit for the different tax rates in the different jurisdictions on the consumer's credit card via the NFC transaction terminal at Friendship Heights, Md. (for example, as identified by the NFC terminal or by GPS).

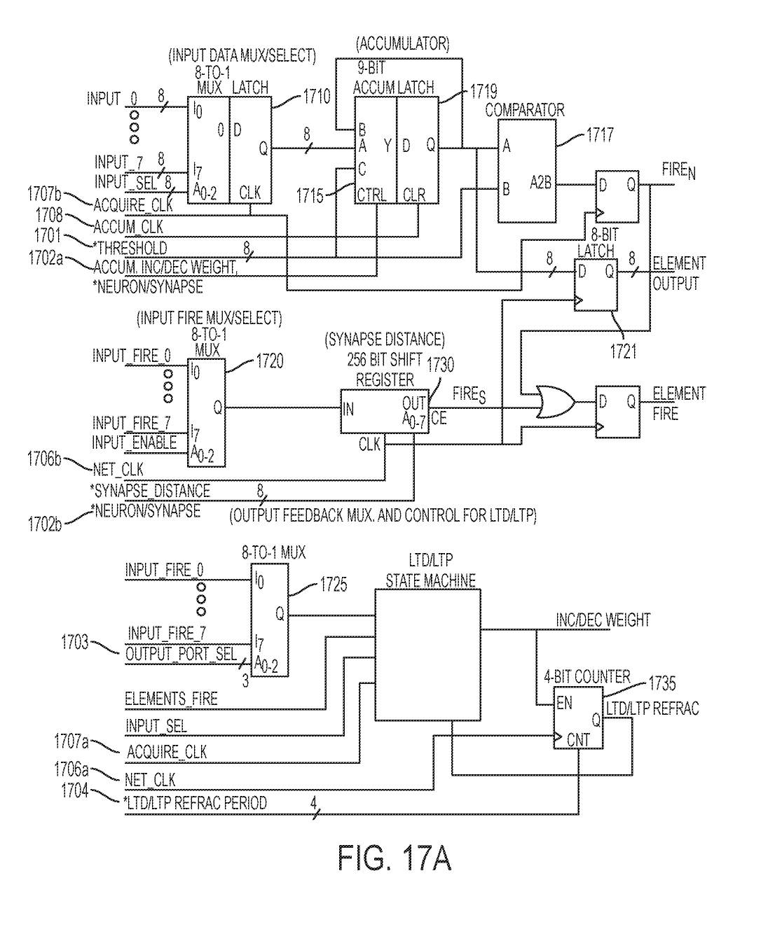

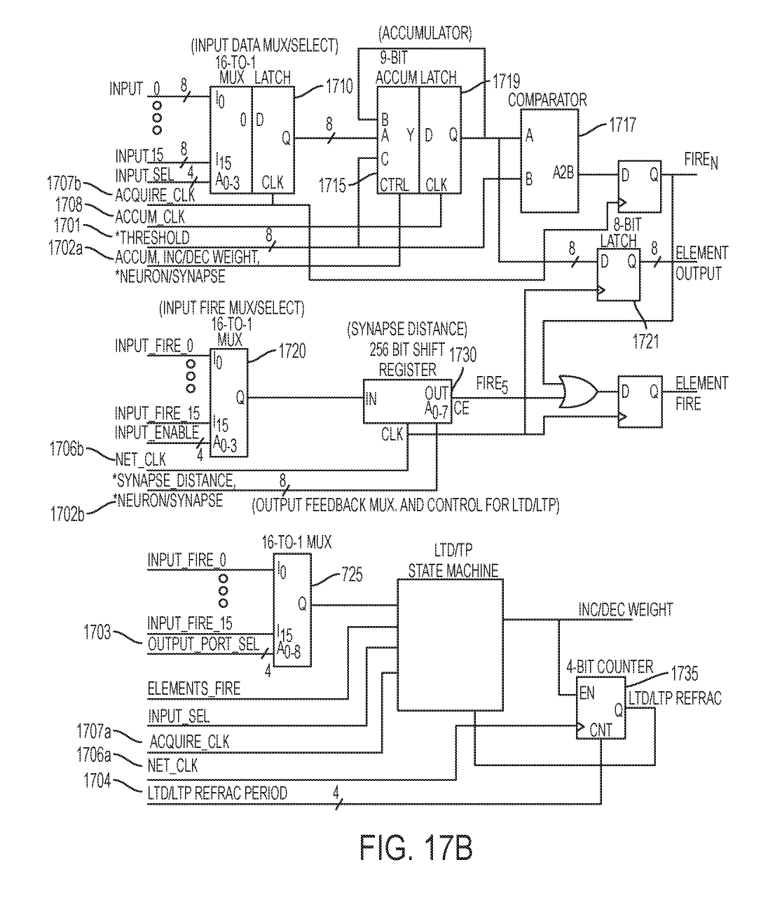

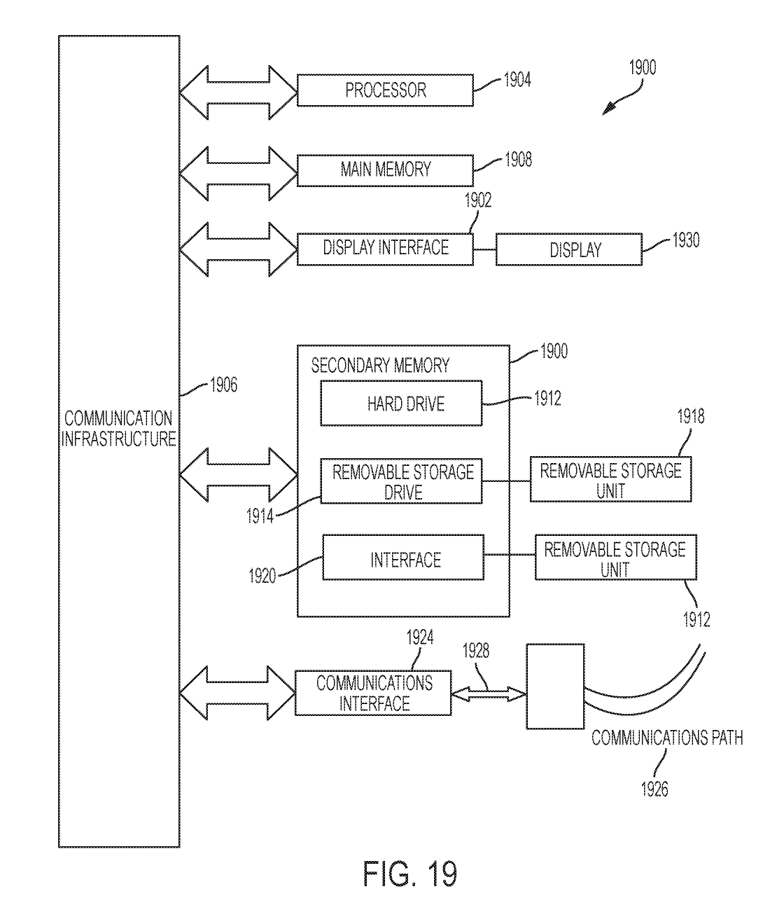

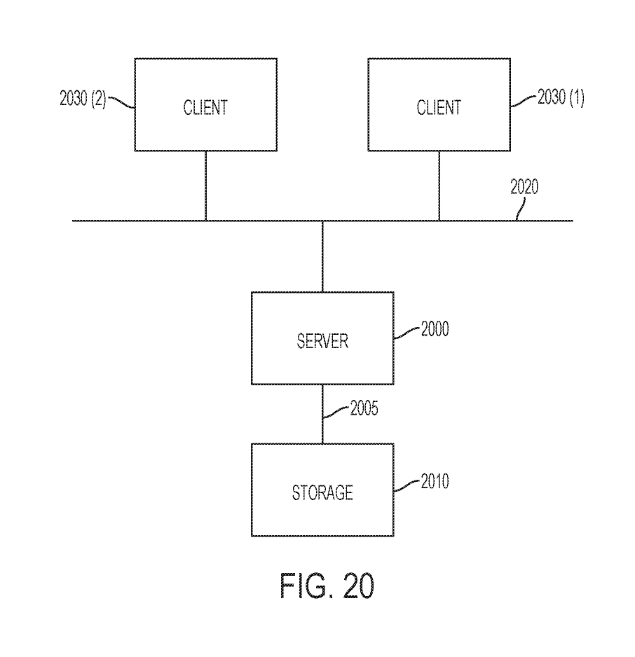

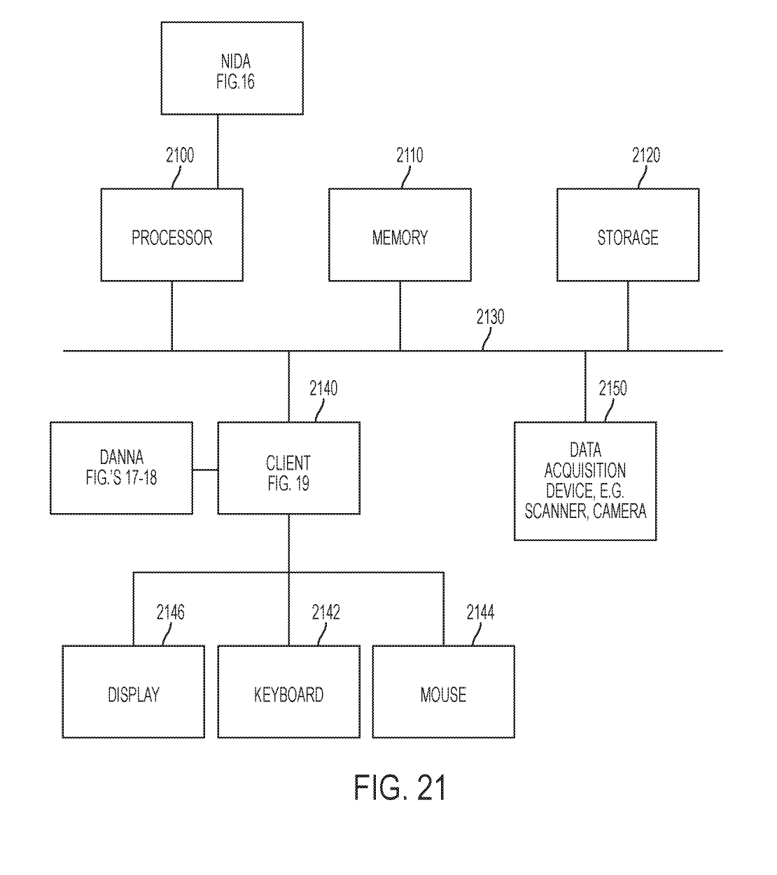

The client/server system for the present method of resolving document errors with respect to the first large nation-wide departments store chain and the second large nation-wide department store's examples will now be described in some detail with reference to FIGS. 16-21 involving, for example, a typical well known personal computer but programmed with a neuroscience inspired dynamic architecture and further including a dynamic artificial neural network array operating in tandem to outperform any human attempt at error resolution. FIG. 16 is taken from U.S. Published Patent Application 2015/0106314 and shows a computational artificial neural network coupled to first and second affective neural networks together comprising an in-board simulated neuroscience inspired dynamic architecture or NIDA. FIGS. 17A and 17B are also taken from U.S. Published Patent Application 2015/0106314 as is FIG. 18 which generally show a dynamic artificial neural network array comprising neurons and synapses which may be selectively adapted to switch their status and connections depending on learning activities as described in related patent applications of Birdwell et al. FIG. 19 provides a generic description of a client or server as is well known in the art. FIG. 20 shows (like FIG. 2) a relationship between client and server and a connecting bus 2020 or communications link such that the server 2010 may be in the cloud (the internet) or local with the client. FIG. 21 is a related figure of client/server system hardware showing the client configuration 2140 (FIG. 19) with an outboard DANNA (FIGS. 17-18) and the processor being a special purpose processor including a NIDA, FIG. 16. Now, the client and server will be discussed with reference to FIGS. 16-21.

Referring to FIG. 16, a computational network 1610 may receive an input from a process of error recognition and resolution of a conventional special purpose computer client processor and provide an output 1640 to the process. The client is preferable an intelligent device equipped with a plurality of data acquisition devices such as GPS, camera, NFC transmission, RF transmission and internet and other telecommunications access. An affective system 1640, 1680 (FIG. 16) may be used (inside the client device) and receive an input 1630 (or 1670 with affective system 1680) from and provide an output to computational network 1620 as well as provide an input 1650 and receive an output 1660 from a second affective system 1680 which may also provide an output to computational network 1620 (which in turn provides an output to a process 1690). An affective system may be determined by the following equations, which could be replaced by a second neural, or discrete event, network. fₜ is the firing rate of the network, measured over a certain window, at time t. This is the input provided to the affective system from the network. dₜ is the desired firing rate at time t. This desired firing rate is provided by the environment and can be changed by a desired firing rate event. The error at time t, eₜ, is calculated:

eₜ=fₜ−dₜ. (1)

There may be no affective system, one affective system or two (or more) affective systems 1640, 1680: for example, a simple affective system 1640 with two parameters and a slightly more complex affective system 1680 with three parameters. The simple affective system may be used in examples below, unless otherwise noted. Both affective systems have the parameter w>0, which is the window size of the system and specifies how often the error is recalculated. In the simple affective system, the change in the threshold at time t is calculated:

Δτₜ=aeₜ. (2)

The parameter a is a weighting term, and the change in the threshold at each time step is proportional to the firing rate error. Δτₜ is the amount that every threshold (or each selected threshold) in the network is changed at time t. This result is passed back to the computational network, and the change is applied to all of the neurons in the network (or the selected subset); if all, since all of the neurons have the same initial threshold value of 0.5, all neurons in the network maintain the same threshold value throughout the simulation. The threshold is bounded to be in the interval [−1, +1], and equation (2) has no effect if it would cause either bound to be violated.

In the more complex affective system, for example, affective system, a second parameter, λ, is added. A geometrically averaged error at time t, Eₜ is calculated:

Eₜ=ΔE_{t-w}+(1−λ)eₜ (3)

The parameter λ of the second affective system may be a decay rate. It defines how much error at times 0 through t−1 will affect the change in the threshold at time t. With this second affective system 1680, the change in the threshold at time t is calculated:

Δξt=aEₜ (4)

where, again, a is a weighting term. In both cases, the result Ar is passed back to the network, and the change is applied to all of the neurons in the network (or the selected subset). Note that the first and second systems are equivalent if λ=0. The same boundary logic applies as with equation (2).

A goal is to demonstrate that a simple affective system interacting with an artificial neural network can have a noticeable effect and can stabilize the average firing rate at desired levels. Most importantly, the terminal when confronted with an NFC transaction terminal and a sales person, an artificial neural network will provide a more intelligent response to a discovered error. To illustrate this approach, an exemplary network (except for those networks trained to complete the pole balancing task) may have 1000 neurons and 10,000 synapses, where Mx=M_{y}=M_{z}=100. This is a relatively large artificial neural network, but compared to the human brain, this is a very small network. It is important to note, however, that the client (intelligent mobile device) is not attempting to model a biological neural system with artificial neural networks; the artificial neural networks are merely motivated by human biology. The tasks these artificial networks are applied to are specific and well-defined such as determining a sales tax error. As such, they can be thought of as analogs to the small portions of the neocortex that implement specific functionalities. Networks with different numbers of neurons and synapses yield similar results, though they are not shown in this work.

The initial neuron placements in the network are random, and the distribution of the synapses is random, but with a higher likelihood of connectivity between spatially close neurons than neurons that are farther apart. In this network structure, there are 200 possible x-coordinate values, 200 possible y coordinate values and 200 possible z coordinate values, resulting in 8×10⁶ possible locations for neurons in this exemplary network. A specific instance or realization of an exemplary network may have neurons at 1000 of these locations, randomly selected according to a uniform distribution, except no two neurons are allowed to occupy the same location.

A typical artificial neural network may have a single input neuron that receives information from the environment. The control, for example, of application of sales taxes may have many input neurons, for example, the NFC tag, a bar code, a document as a whole such as a sales receipt or an invoice, the document items' relation to one another and the sales taxes applied for the product items. The “environment” in a setup consists of two things: pulses sent to the input neuron at, for example, exponentially-distributed random intervals, with a mean firing rate of 0.1 firings per unit time, and an input to the affective system that sets the current desired firing rate, in this example, for the aggregate of all neurons in the network. This input plays the role of a persistent external excitation used to initiate and promote firing events in the network. This is an extremely simple environment and may be implemented on an intelligent NFC equipped mobile device (Android or Apple and may be a component of Apple Pay or Google Wallet); more complex tasks have richer environments that provide meaningful information to the network and receive signals produced by the network (see the sales tax examples for the large nation-wide department store involving just one tax jurisdiction and the Bloomingdale's exchange involving two sales tax jurisdictions). The affective system may monitor the behavior of the network and applies the threshold changes to the network every w (the window size) units of simulation time. For the tests described in this example and by way of example, w=10.

All neurons in the network may have a refractory period of one, which means that there is an upper limit on the firing rate of the network; since each neuron can fire at most once in a single simulated time step, the maximum firing rate of the network per time step is 1000. This assumes that the network is fully connected, which is not a requirement placed on the random initialization of the networks. There may be neurons that have no incoming synapses or neurons with no outgoing synapses, which would further limit the maximum firing rate of the network, and the network is not necessarily connected.

In preliminary experiments, the parameters of the affective system are set to be a=0.001 and w=10. The long term potentiation/long term depression refractory periods are set to be 10, and the weights are adjusted up (for LTP) and down (for LTD) by 0.001. The parameters used in the sales tax application tasks are slightly different and are described in the Table 1.

TABLE 1
Network and Affective System Parameters

| Parameter | Value |
|---|---|
| Mₓ | 100 |
| M_{y} | 100 |
| M_{z} | 100 |
| Network granularity δ | 1 |
| A | 0.001 |
| Λ | 0 |
| LTP/LTD refractory | 100 steps of simulated time |
| Amount LTP/LTD adjusted | 0.001 |
| Window size w | 20 |

A first goal is to demonstrate that, even with two very simple controlling affective systems, the network's firing rate can be adjusted and stabilized. The environment provides the single firing rate (for example, a value between 50 and 950) to the affective system at the beginning of the simulation. The simulation may be allowed to run for 10,000 simulated units of time, where the input pulses are randomly applied as described above, and the affective system(s) update(s) the threshold of the network every ten simulated time units (w=10).

Referring now to FIGS. 17A and 17B there are shown 8 bit and 16 bit processing equivalent dynamic artificial neural network arrays (DANNA's) for receiving documentation error inputs and resolving errors in parallel with neuroscience inspired dynamic architecture (NIDA) FIG. 16. These may be implemented in a client device but, being hardware devices, may require modification, for example, of a known Apple or Android based device. Certainly, a DANNA may be used to advantage at a cloud-based server supporting a client. An array of programmable adaptive neuromorphic elements may use a field programmable gate array FPGA and the Dynamic Adaptive Neural Network Array or DANNA component models. A VLSI (application specific integrated circuit (ASIC)) may also be used. Embodiments of a DANNA will now be described with reference to FIG. 17A through FIG. 18. The capacity, logic structures, functions and layout of Xilinx Virtex-7 FPGAs (a Xilinx Zinq FPGA with an ARM processor may also be used to construct a DANNA with programmed control) provide the potential to support useful array sizes, up to 10,000 (or more) programmable elements. Programming, control and I/O interfaces are described to enable the creation of a target neural network and the monitoring of its operation. Finally, the potential performance of an FPGA-based DANNA is discussed with a VLSI-based DANNA implementation.

A model of a neuron inspired by the Hodgkin-Huxley model may comprise operating components such as a neuron charge accumulator, a threshold and a refractory period, and may also comprise a synaptic propagation delay and a weight. This neuron element may introduce dynamic behaviors in the network, serving as memory and influencing system dynamics. Unlike most proposed ANN architectures, but similar to natural neural processes, these dynamic effects may be distributed throughout the network, and are directly influenced in the present ANNs by the evolutionary programming methods utilized to construct and adapt the ANNs for specific purposes such as input, control, anomaly (error) detection, classification and resolution.

A primary function of a DANNA neuron element (which may also serve as a synapse to be discussed further herein) is to accumulate “charge” by adding the “weights” of firing inputs from connected synapses to its existing charge level until that level reaches a programmable threshold level. Each neuron has an independently programmable threshold 1701 received from a threshold register (not shown). Referring to one of FIG. 17A or 17B, the depicted circuit element is advantageous in that it may comprise either one of a neuron and a synapse. The neuron will be discussed first. Threshold input 1701, indicated by an asterisk or star *, receives a threshold value stored in a register not shown and provides that value to Accum (Accumulator) input C and to Comparator 1717 input B. Inputs 0-8 (8 bits in FIG. 17A, 0-15 or 16 bits in FIG. 17B) to MUX/Select 1710 are selected by Input Sel input (3 bits, FIG. 17A; 4 bits FIG. 17B). An Accum, Inc/Dec Weight, Neuron/Synapse register (not shown) stores whether the element is a neuron or synapse and provides an increment/decrement value to CTRL input of Accumulator 1715. Meanwhile the charge value stored in Latch is output by an 8 bit lead to input A of Accum/Latch 1719 for comparison with Threshold at comparator 1717. When the threshold is exceeded at 1717 and given clock Acquire_Clk a Fire signal is output and latch 1721 outputs Element Output. When the threshold is reached and the element is a neuron, if the neuron is not in its refractory period, the neuron fires, and the neuron's charge is reset to a bias level, dependent on the design parameters for the network. If the neuron is within its refractory period defined by an LTD/LTP Refrac period input from a register not shown to CNT input 1704 of 4-bit counter 1735, then the neuron maintains its charge but does not fire. An LTD/LTP state machine receiving an Element Fire signal from above helps determine if Inc/Dec Weight output to CTRL input of 1719 decide whether to fire or continue accumulating. Thus, a neuron can accumulate charge during its refractory period (input 1704), but it cannot fire during this period. As soon as a neuron fires, it enters its refractory period. The refractory period for all neurons is preferably a constant value set for a given application or operational characteristic. One utility of the refractory period is to limit the maximum firing rate of neurons which typically limits energy consumption by the neuron element of a DANNA.

A weighted-sum threshold activation function for the neuron charge is chosen given its implementation simplicity and functionality, but other activation functions could be implemented (e.g. linear, sigmoid or Gaussian).

The neuron charge function Hₖⱼ(t) can be expressed as:

$${H}_{kf} ( t ) = {\sum }_{i = 1}^{N} {W}_{t} ( t ) {x}_{t} ( t ) + {H}_{kf} ( t - 1 )$$

where kj is the location address in the 2-dimensional array (kjl in a 3-dimensional array), N is the number of neuron inputs, w, is the weight of input xᵢ and t is the discrete sample time for network sequencing. Weights can be negative or positive discrete values with minimum and maximum limits set by the functional requirements of the target applications. For this implementation we chose to use signed 8-bit weights (−128 to +127) and a 9-bit charge accumulator.

The neuron activation function aₖⱼ (the point at which a neuron will fire its output) can be expressed as:

$${a}_{kf} ( t ) - f ( {H}_{kf} ( t ) ) - \{ \begin{matrix}1 if {H}_{kf} ( t ) \geq θ ( t ) \\ 0 if {H}_{kf} ( t ) < θ ( t )\end{matrix}$$

where [symbol] is the neuron's programmable threshold. When the neuron's charge reaches its threshold level the charge of the neuron is reset to a predetermined bias level before starting a new charge accumulation phase. The bias value is the same for all neurons in the network in the current design. For this implementation the thresholds are limited to binary values from 0 to +127. This neuron model follows to some extent a computational model for a neuron proposed by Rosenblatt (Rosenblatt 1958).

Additional features of our neuron model are the number of inputs/outputs and its firing refractory period. The implementation of FIG. 17A supports 8 input/output (I/O) ports connecting to nearest neighbor elements. The implementation of FIG. 17B supports 16 input/output ports to Input Data Mux/Select 1710 selected by Input Sel input as a 4 bit select input to Mux (3 bit select in FIG. 17A for 8 input/output ports). Note that each port can be an input and/or an output, and each port that is enabled to accept an input used must connect to an element (feeding the neuron) programmed as a synapse. Input port sampling is done sequentially by Input Sel and must be randomized to avoid having a single synapse dominate the interactions with the neuron, and to avoid specified, undesirable learning behaviors such as crediting LTP/LTD actions to a preferred or single synapse. This is done by having the first port address sampled in a network cycle be random and each subsequent port address be in sequence from the first address (such as binary ordering by port number).

The neuron refractory period defined at 1704 is the amount of time, measured in network cycles, which a neuron must hold off firing from a previous firing condition. The University of Tennessee has set the neuron refractory period to one network cycle, meaning if the input firing rate and weights are sufficiently high, a neuron can fire on every network cycle. If the firing rate for neurons needs to be programmable, an alternate design may implement a programmable firing refractory period that may be input 1704.

A model for neurons of a DANNA allows them to be either input neurons or internal neurons (not connected as input neurons or output neurons in the DANNA). Input neurons may be placed along specified edges of an array to facilitate routing. Neurons may be connected to other neurons via one or more synapses. Synapses are directed (later shown as arrows), so each neuron has one or a set of synapses to other neurons and a set of synapses from other neurons.

As indicated above the element of FIG. 17A or FIG. 17B may be selected to comprise a synapse in the alternative to serving as a neuron. Synapses may also connect to other synapses, for example, in order to implement delays in excess of the capability of a single synapse, and to implement longer signal path lengths between neurons they connect. Synapses are defined by the neurons they connect; each synapse may be directed from one neuron to another neuron. Each synapse circuit element represents the distance between two neurons and the weight (or strength) of the synaptic connection. The distance between the two neurons is represented as a delay, implemented using a first-in/first-out (FIFO) shift register clocked at the network cycle rate, and determines how long it takes for charge to travel along the synapse where the charge value is stored and fed to Accum, Inc/Dec Weight 1702a. Also note that Synapse_Distance is fed at input 1702b Synapse_Distance, Neuron/Synapse. The weight of the synaptic connection determines how much charge arrives at the second neuron after the first neuron fires. This network model does not implement the concept of myelination, but myelination is equivalent to a reduction of the (programmable) delay. Alternatively, a hardware implementation may be used, for example, a clock divider circuit for changing delay or by connecting synapses together of programmed delay to double delay. If two synapses are each of length d, then it takes the same amount of time (delay) for charge to travel from one end of each synapse to the other. Synapses of a DANNA capture selected features of both axons and synapses found in biological neural networks.

A primary function of a DANNA synapse circuit element is to adapt and transmit a weighted firing signal based on: 1) the firing rate of its input neuron, 2) the firing conditions of its output neuron and 3) its programmable distance which represents the effective length of the synapse. Again, note inputs Accum, Inc/Dec Weight, Neuron/Synapse 1702a and Synapse_Distance, Neuron/Synapse 1702b. Two of the unique characteristics of our synapse model are: 1) the weight value held by the synapse can automatically potentiate (long-term potentiation, or LTP) or depress (long-term depression, or LTD) (Inc/Dec) depending on the firing condition of its output neuron and 2) the ability to store a string of firing events in its “distance FIFO” (Synapse_Distance input 1702b) to simulate a synapse transmitting a set of firing events down its length. Note we are preferably implementing a synapse's length into a representative number of discrete time periods using a programmable shift register.

A synapse can have one (out of eight) I/O ports (FIG. 17A or one of 16 in FIG. 17B) enabled as an input and one (out of eight, FIG. 17A; out of 16, FIG. 17B) I/O ports enabled as an output (Input Fire Mux/Select 1720). When a synapse receives a firing event from an input neuron, it places this event on its distance FIFO 1730. Preferably, multiple input events received during each element clock cycle (1706a) are OR'ed together to create a single input event to the FIFO register. The distance FIFO 1730 is a programmable shift register that can store from 1 to 256 firing events (one per network cycle programmed as the “distance” of the synapse). When each firing event reaches the output of the distance FIFO 1730, the present weight value stored in the synapse is transmitted as a firing event on its output port (Element Fire).

As mentioned, the synapse weight will automatically adapt based on its firing condition and the firing response of its output neuron. LTP and LTD occur in biological brains; it is speculated that they play a major role in learning. The adaptive synapse weight function, w_{kf}(t), can be expressed as follows:

$$if {S}_{kf} ( t ) = 1 , then {w}_{k} ( s + 1 ) = \{ \begin{matrix}{w}_{kf} ( t ) + LTD if {a}_{neuron} ( {t}_{1} ) = 1 \\ {w}_{kf} ( t ) + LTP if {a}_{neuron} ( {t}_{1} ) = Q and {a}_{neuron} ( {t}_{1} + 1 ) = 1 \\ {w}_{kf} ( t ) if {a}_{neuron} ( {t}_{2} ) = Q and {a}_{neuron} ( {t}_{2} + 1 ) = 0\end{matrix}$$

where S_{kf}(t) is the synapse output firing condition, aₙₑᵤᵣₒₙ(t₂) is the activation function or firing condition of the neuron connected to the synapse's output at the time during the network cycle it samples the synapse output, LTD is the “long term depression” value for the synapse, and LTP is the “long term potentiation” value for the synapse. Note that (t₃|1) is the next input sample cycle after the neuron has sampled the synapse output; given eight inputs, the network cycle is divided into eight input sample cycles.

For a preferred implementation, the LTP and LTD values are set at +1 and −1, respectively. Therefore, a synapse's weight is increased by one if it causes its output neuron to fire and is decreased by one if it fires when its output neuron is already firing (Accum, Inc/Dec Weight, Neuron/Synapse 1702a). It is unchanged in all other conditions.

Finally, a synapse has a programmable LTP/LTD refractory period (LTD/LTP Refrac Period 1704). This programmable value (ranging from 0 to 15) represents the number of network cycles a synapse must wait from its last weight potentiation or depression before it can adjust its weight again. This value is input to Cnt input of 4-Bit Counter 1735. This function limits the rate of potentiation/depression of a synapse's weight. All potentiation and/or depression conditions experienced during the LTP/LTD refractory period are ignored; they have no effect on the synapse weight. The utility of the LTP/LTD refractory period is to adjust the relative rates of change of synaptic weights and neuronal firing activity. The LTP/LTD refractory period and the neuron refractory period can be used in combination.

An array element shown in FIG. 17A or FIG. 17B implements all the functions necessary to support its operation as either a neuron or a synapse where FIG. 17A portrays an eight input of 8 bits each embodiment and FIG. 17B portrays a sixteen input embodiment of 8 bits each to Mux/Latch 1710. To minimize the physical implementation size of the array element, as many functional components as possible are used to support portions of each neuromorphic function. To maximize performance and minimize size, we, by preference, may use a simple state-machine design (LTD/LTP State Machine) and avoid the use of digital signal processors, floating-point units, arithmetic-logic units, memory arrays and other common microprocessor units. However, a more complex state machine and further processing may be implemented in alternative embodiments (for example, Xilinx Zinq).

The states used to sequence the array element are defined as follows: 1) Select an input port (1 of 8 or 1 of 16) and 2) acquire input fire condition (Note: all 8/16 ports of an element are sampled (or not) during a single network cycle). (Inputs to neurons, for example, may be selectively enabled or ignored if they are not to fire (on a neuron by neuron basis). Next, check the fire condition of the element assigned to the output port (used to determine LTD/LTP if the element is configured as a synapse). Load the synapse FIFO 1730 with the input fire condition if the element is a synapse. 3) Accumulate the acquired input weight with the current charge state at accumulator 1715, 1719 and compare the accumulated charge with the programmed threshold at comparator 1717 if the element is configured as a neuron. The accumulator 1715, 1719 holds the LTD/LTP weight if the element is a synapse. Depress or potentiate synapse the weight (Inc/Dec Weight 1702a) based on the firing condition of the element assigned to the output port. 4) Fire the output and reset the accumulator 1715, 1719 to the bias value if the charge≥the threshold if the element is a neuron and optionally if the neuron is not refractive (for refractory periods>1). Fire the output if a fire event is at the output of the synapse FIFO 1730 if the element is a synapse.

The “Fire Output” and “Acquire Input” states may overlap, reducing the state machine to two states. A network cycle consists of eight (sixteen) element cycles, and the element may sample eight (FIG. 17B, sixteen) inputs during a single network cycle. Therefore, in the example of FIG. 17A, it takes eight (FIG. 17B, sixteen) element cycles to complete one network cycle. The following list of functional components is implemented in the array element; these components are illustrated in the block diagram of the element in FIG. 17A for 8 inputs and FIG. 17B for 16 inputs.

Referring now to FIG. 17A, the following types of programmable registers are used in FIG. 17A: An 8-bit Threshold/Weight Register (stores threshold for neuron, or weight for synapse) and is an input 1701; an 8-bit Synapse Distance Register (synapse mode only) 1730 receives inputs IN from Input Fire Mux/Select 1720, Net_Clk 1706b and Synapse_Distance 1702b; an 8-bit Input Enable Register 1710 receives 8 bit inputs 0-7 (FIG. 17A) or 0-15 (FIG. 17B) and Input Sel as well as CLK from Acquire_Clk 1707b; a 4-bit Mode/Output Select Register (Neuron/Synapse; 3-bit (FIG. 17B, 4-bit) output port select 1703 if a synapse, which is used to determine which connected elements output should be monitored for LTD/LTP), and a 4-bit LTD/LTP Refractory Period Register (synapse mode only) (input 1704 to 4-bit counter 1735). Note that a star * in the drawings FIGS. 17A and 17B is used to designate such registers as inputs. All inputs are clocked.

The 8×9-bit I/O port 1710, 1720 will now be described with reference to FIG. 17A. Each port includes an 8-bit uni-directional I/O data interface to communicate “weights” to 1710 and a “fire” signal to 1720 respectively. An I/O can communicate a “fire event” from a neuron to a synapse or a “weight” from a synapse to a neuron. The 8-to-1 input port multiplexer and latch 1710, 1720 is further described as follows. Each input port is 9-bits wide (1-bit “fire” to 1720 and 8-bit “weight” signals to 1710). The network provides global input select signals (Inp_Sel) to support sequencing through all connected inputs. A pseudo-random number generator may be used to randomize the input sampling sequence during each network cycle. Global Clocks and Input Selects may be implemented in any known manner depending on choice of clock rate and divided as necessary to provide select and acquire and the like for the desired network).

The 9-bit accumulator (adder 1715, comparator 1717 and latch 1719) will now be described. This holds and calculates “charge” for a neuron or “weight” for a synapse. Comparator 1717 also compares “charge” to “threshold” for a neuron. The accumulator 1715 accumulates input firings from all enabled inputs to the neuron (inputs enabled selectively from 0 to 8 (FIG. 17A) or 0 to 15 (FIG. 17B). The weight of each input firing event is stored and added to the “charge” in the order it is sampled. Each weight is an 8-bit signed integer. When an element is a synapse, its weight will be depressed or potentiated, by adding −1 or +1 respectively, (Inc/Dec Weight 1702a) depending on the effect the synapse firing event has on its connected neuron.

The 8-bit output register 1721 to hold output communications to connected array elements (the “threshold” when configured as a neuron and the “weight” when configured as a synapse) will now be described. The output register value (Element Output) is driven onto the output port during a “firing event” and held active for one network cycle. At all other times the output is zero.

A Synapse Distance FIFO 1730 stores input firing events to a synapse and maintains the firing delays between those events. This is implemented via a 1-bit wide x 256 entry shift register 1730. The Synapse Distance Register 1730 selects the appropriate “tap” off the event shift register to implement the “distance” (a delay) associated with the configured synapse. Equivalently, a signal injection point may be selected.

A 4-bit counter and register (or 16-bit shift register) 1735 with programmable length will now be described. This holds and implements the LTP/LTD refractory period for a synapse. A global programmable refractory period register (output designated LTD/LTP Refrac Period 1704) is used to drive a 4-bit refractory period “length” to all elements.

Clock inputs are created by a network clocking circuit and distributed to manage fan-out and minimize clock skew. Fan-out implements a way to have more than 8 (or 16 or more) input/outputs as will be discussed further herein. These include a Global Network Clock (Net_Clk) 1706a and 1706b, an Acquire/Fire Clock (Acquire_Clk) 1707a and 1707b, and an Accumulate Clock (Accum_Clk) 1708, provides accumulated clock time. The Global Network Clock sets the network cycle time. Acquire/Fire Clock 1707 controls the element cycle time and Accumulate Clock 1708 enables the accumulator latch 1719 input CLK to perform two operations every element cycle (load and accumulate). Signal line and device names are chosen as arbitrary and, when used in the claims, such signal line and device names are intended to refer to any such signal line and device name that may be used to perform a similar function, in a similar way to accomplish a similar result. For example, accumulate clock refers to a function of accumulating clock time in time units measured according to the application as real time or selected time units that may be intentionally slowed, for example, to study a particular event in a slow motion visualization of a neural network array event process.

A Programming/monitoring interface (not shown as a PCIe Interface) (or other known interface technology or method may be used) enables register reads/writes from/to the external interface. In the current implementation, each element in the array is directly addressed via a multiplexed 8-bit address/data port (which supports a 16-bit global element address and an 8-bit data port), a 3-bit element register select, a read/write signal, a strobe, a clock, a Run/Halt signal and Reset (16 signals total).

FIG. 18 is a bock diagram providing for sixteen element inputs of eight bits each and so a four bit (1 of 16) select. It is not believed necessary to discuss FIG. 18 in great detail. The element code appended hereto is for the sixteen bit element and associated registers shown in FIG. 17B (which like FIG. 17A may be a neuron or a synapse).

An array of elements may be modified in alternative implementations to provide additional control and monitoring functions. The element array may be structured as a 2-dimensional array that is k elements wide by j elements high (elements being one of a synapse and a neuron). Each circuit element connects to eight (16 or 24 or 32 . . . ) of its nearest neighbor elements (directly above, below, to the right and left, and diagonal), except for elements on the edge of the array, which have a limited number of connections. Some of the edge elements are used as inputs/outputs to external signals and devices and are neuron elements. One may also place static “pass-thru” elements (1790) throughout the DANNA array. These pass-thru elements provide a static connection between corresponding horizontally, vertically and diagonally connected ports. The pass-thru element provides additional flexibility to the network configuration software, allowing it to avoid creating chains of connected elements that would otherwise block access to other parts of the array.

A pass-thru element having 8 inputs from 8 different outputs for an array element. A pass-thru (or pass-through) element or cell allows signals to cross paths so that one pathway does not block another signal. As per FIG. 18, an eight I/O element may be shown. Any input shown in FIG. 18 (the eight input element) may receive an input as an output from any of eight connected elements. Each element (in this figure called a pass-thru element or “cell”) may receive an output from eight others without blocking another signal. So starting from 12:00 on the dial, input 0 of cell/element 1710 may connect to I/O 4 of Cell X, Y+1. Input 1 of cell/element 1710 may connect to I/O 5 of cell/element X+1, Y+1 and so on to I/O 7 at 10:00 on element 1710. I/O's may be sequentially addressed to prevent signal blocking generally and, in particular, in a static pass-thru element. Other numbering schemes may be used in FIG. 17 or 18 and the numbering scheme shown is merely exemplary of all possibilities.

Referring again to FIG. 18, in one embodiment, the FPGA DANNA array of circuit elements connects to, for example, a PCIe interface that is used for external programming and adaptive “learning” algorithms that may monitor and control the configuration and characteristics of the network and may have array circuit elements 1021, 1023, 1031, and 1033 that may be located on an edge of the array and may have external inputs or outputs. Array elements, including 1021, 1023, 1031, and 1033 may preferably also have inputs or outputs that are internal to the array. Array circuit elements and components thereof may be digital or analog, but as will be seen in the discussions of FIGS. 17A and 17B, the FPGA implementation of a circuit element selectively being a neuron and a synapse may comprise digital circuit components such as registers of digital data. Analog circuit elements that may be used in constructing a circuit element of an array (besides the implementations shown in FIGS. 17A and 17B by way of example) include a memristor, a capacitor, inductive device such as a relay, an optic device, a magnetic device and the like which may implement, for example, a memory or storage. “Analog signal storage device” as used in the specification and claims shall mean any analog storage device that is known in the art including but not limited to memristor, phase change memory, optical storage, capacitive storage, inductive storage (e.g. a relay), magnetic storage or other known analog memory device.”

Other interfaces may be used as indicated in FIG. 18. Interface and control 1040, such as a FMC bus, a serial or parallel communication interface such as a Universal Serial Bus (USB) interface using, for example, the USB 2.0, 3.0, or newer standard, a Bluetooth interface, an interface using one or more pairs of conductors, or a network interface using, for example, copper wiring such as CAT6 {or CAT5e, such as are used for Ethernet, Fast Ethernet, or Gigabit Ethernet, or 10G Ethernet, Myrinet, and Infiniband, fiber optic such as OC-3, OC-12, OC-48, ATM, or a point-tip-point data transfer protocol using, for example, single-mode or multi-mode fiber optic cable, a HDMI interface, or a wireless network interface including circuit-switched and packet data cellular such as 3G, 4G, 4G LTE, and enhanced protocols, Wi-Fi such as 802.11, as exemplified by the 802.11a/b/g/n/ac variants and future proposals and standards, and industrial automation, communication, and/or control protocols such as, by example, Modbus and its variants, Controller Area Network (e.g., CANopen), Ethernet/IP, and specialized protocols such as Z-Wave and ZigBee. Additional devices may be used to implement an interface such as a computer or processor known in the art, where the processor, or a processor core, may be co-resident with a device or devices implementing one or more DANNA(s) on a common semiconductor substrate. For example, a DANNA may be implemented using one or more FPGA, VLSI or ASIC devices, in any combination, and may include a mixture of analog and digital components, may have an interface to a first special purpose processor, which may be a computer and which may optionally be resident on the same semiconductor substrate as a DANNA, running special purpose software to provide for transactions, including command and data transfers, between the DANNA. (or multiple DANNAs) and a second special purpose processor. The second special purpose processor may also be a computer and may optionally be remote from the first special purpose processor, such that the second special purpose processor controls the operation of the DANNA and optionally may configure the DANNA and perform optimization of one or more artificial neural networks configured on or in the DANNA special purpose software. By example, any of the interfaces or interface technologies or standards listed above may be utilized to implement an interface between any two or more special purpose processors and/or between a special purpose processor and a device or devices that implement one or more DANNA(s). There may be multiple first special purpose processors and multiple DANNAs implemented on or in one or multiple FPGA/VLSI/ASIC devices or combinations. Each first special purpose processor may execute special purpose software that implements a capability to facilitate transactions between the DANNAs and the second special purpose processor. Also, there may be more than one second special purpose processor that operates in a coordinated manner using interfaces and communications protocols known in the art to implement a solution to at least one of a control, detection, or classification application. The interface 1840 provides for communication between the DANNA and a control and, optionally, optimizing device 1860, which is optional and may not be present in stand-alone implementations.

Each element may sample eight of its input ports of FIG. 17A (or 16 of FIG. 17B) within a network cycle. This is accomplished using a global input select function. A 63-bit linear-feedback shift register (LFSR) is used with a loadable 3-bit counter to generate random starting address sequences for the input selects which guarantee that the first element selected during each network cycle is randomly chosen with roughly uniform probability. Eight element-inputs (FIG. 17A circuit element) may be sequentially sampled beginning with the randomly chosen one within a single network cycle. Randomization of input sampling is important to prevent the domination by one input of the behavior of a neuron.

A design feature of the element array is the numbering scheme used for the I/O ports. Connected I/O ports on adjacent network elements may have the same port number to facilitate implementation of the synapse's LTD/LTP function. The element I/O port number scheme used is shown in FIG. 18.

The Xilinx Vivado™ Design Suite was used for the design, implementation, simulation and layout of the DANNA element array. VHDL was used as the description language for all designed components. The code is attached hereto for the several components of each circuit element. We targeted the Virtex-7 series of Xilinx FPGAs. The main logic resource used on the Xilinx 7-series FPGAs is the “configuration logic block” or CLB. Each CLB contains two Slices, which each have four 6-input “look-up tables” (LUTs), eight flip-flops and arithmetic carry logic. There is also logic to implement wide multiplexers and long shift registers. Other tools and hardware may be used such as Xilinx Zinq and Alterra FPGA by way of example.

An element implementation may require, for example, 84 LUTs and 64 flip-flops. One may fit the element in a tightly arranged 28 Slices or 14 CLBs using the Vivado floor planning and placement tools. Note that none of the on-chip digital signal processors (DSPs) or Distributed Ram Blocks was used in the element design as can be seen in either FIG. 17A or 17B.

Element simulations of DANNA and construction of elements verify full functionality for both neuron and synapse modes of a circuit element of either FIG. 17A or 17B. A target clock rate for the network may be 1 MHz and 8 MHz for the element (sample rate for the inputs). Further timing simulations showed we may clock the network at 8 MHz and the element at 64 MHz. A 10 MHz network clock and 80 MHz element clock rate are achievable (if not higher rates). The higher clock rates are important because evolutionary optimization (EO) is typically used to design a DANNA for a specific implementation and application. EO ideally configures multiple DANNAs, simulation or execution of them against the application (for example, for signal detection or classification, or to control a (possibly simulated) physical object's behavior, and a limiting factor in the optimization may be execution and evaluation of the performance of individual DANNAs. Higher clock rates translate directly to more rapid convergence of the EO design steps.

The global functions were implemented and tested using the same design tools and simulation models as the element. This included the Clocks, Input Select, PCIe, programming interface, and programmable registers for network control and LTD/LTP refractory period. The PCIe and programming interface took the most logic to implement. By reducing the PCIe interface 1010 to a single lane (lx), this significantly reduced the logic required to interface the array to an external computer.

A final design was configured, loaded and tested on two different Xilinx evaluation boards: the VC709 evaluation board featuring the XC7VX690T FPGA and the VC707 evaluation board featuring the XC7VX485T. The 485T FPGA has 75,900 Slices, and the 690T FPGA has 108,300 Slices. An array of approximately 2500 elements was placed on the 485T FPGA and an array of approximately 3500 elements on the 690T FPGA. Using Xilinx's largest Virtex-7 FPGA, the XC7V2000T, an element array of approximately 10,000 elements may be constructed. With the array sizes achieved, many solutions needing a neural network array (DANNA) can be supported.

Referring now to FIG. 19, there is shown a typical client of a client network of a family of clients such as in a household or larger entity such as a common community (for example, a college or university). In one embodiment, the invention is directed toward one or more client computer systems such as intelligent mobile devices or personal computers capable of carrying out the functionality described herein having associated memory and databases. An example of a computer system 1900 of a sophisticated mobile device may be an Android or Apple based operating system intelligent computer system having Apple Pay/Google Wallet, NFC tag reading and the present application software for identifying potential or actual data errors and resolving them while an example of a personal computer may be a client running a Windows or Apple based operating system. The example does not show all aspects of a mobile device such as the camera, a clock, a time of day and date calendar, a GPS unit, an accelerometer and other features of a typical intelligent mobile device or personal computer. However, such features of an ever improving digital camera are typically found in mobile devices/personal computer known in the art and even comprise video cameras for capturing sequences of images if selected by a user.

Client computer system 1900 includes one or more processors, such as processor 1904. The processor 1904 is connected to a communication infrastructure 1906 (e.g., a communications bus or network). Various software aspects are described in terms of this exemplary computer system. After reading this description, it will become apparent to a person skilled in the relevant art(s) how to implement the invention using other computer systems and/or architectures.

Users of mobile devices/personal computers/cloud servers communicate with computer system 1900 by means of communications interface 1906 or other interface known in the art. A typical client computer used by a user may have a similar structure to computer system 1900, the difference being that computer system 1900 may comprise databases and memory (PD, PPD, SD, SPD, personal profile and image databases. A client device, on the other hand, provides an individual user with access to any of these for receiving new document or images or doing any of the recognition of the images and image portions such as text fields, logos and such as discussed above.

Computer system 1900 can include a display interface 1902 that forwards graphics, text and other data from the communication infrastructure 1906 for display on the display unit 1930. A display, as will be described herein, may provide a touch screen for, for example, entering data manually. In either the first or the second large nation-wide department store chain examples, NFC tags may be read, bar codes scanned, images of products captured, documents may be scanned on site using a camera of the intelligent mobile device and resolution of either type of error in application of sales tax may be resolved on site with the department store transaction terminal.

Computer system 1900 also includes a main memory 1908, preferably random access memory (RAM) and may also include a secondary memory 1910. The secondary memory 1910 may or may not include, for example, a hard disk drive 1912 and/or a removable storage drive 1914, representing a floppy disk drive, a magnetic tape drive, an optical disk drive, etc. The removable storage drive 1914 reads from and/or writes to a removable storage unit 1918 in a well known manner. Removable storage unit 1918 represents a floppy disk, magnetic tape, optical disk, etc. which is read by and written to by removable storage drive 1914. As will be appreciated, the removable storage unit 1918 includes a computer usable storage medium having stored therein computer software and/or data for document error recognition and error/issue resolution.

In alternative aspects, secondary memory 1910 may include other similar devices for allowing computer programs or other code or instructions to be loaded into computer system 1900. Such devices may include, for example, a removable storage unit 1922 and an interface 1920. Examples of such may include a program cartridge and cartridge interface (such as that found in some video game devices), a removable memory chip (such as an erasable programmable read only memory (EPROM), or programmable read only memory (PROM)) and associated socket and other removable storage units 1922 and interfaces 1920, which allow software and data to be transferred from the removable storage unit 1922 to computer system 1900.

Computer system 1900 also includes a communications interface 1924 which may be a cellular radio transceiver known in the cellular arts or data line or network known in the data networking arts that is protected, for example, for security by encryption such as 2048 bit encryption. Communications interface 1924 allows software and data to be transferred between computer system 1900 and external devices such as cloud servers and database servers. Examples of communications interface 1924 may include a modem, a network interface (such as an Ethernet card), an RF communications port, a Personal Computer Memory Card International Association (PCMCIA) slot and card, etc. Software and data transferred via communications interface 1924 are in the form of non-transitory signals 1928 which may be electronic, electromagnetic, optical or other signals capable of being received by communications interface 1924. These signals 1928 are provided to communications interface 1924 via a telecommunications path (e.g., channel) 1926. This channel 1926 carries signals 1928 and may be implemented using wire or cable, fiber optics, a telephone line, a cellular link, an radio frequency (RF) link and other communications channels.

In this document, the terms “computer program medium” and “computer usable medium” are used to generally refer to media such as removable storage drive 1914, a hard disk installed in hard disk drive 1912 and signals 1928. Not all mobile devices have all these features. These computer program products provide software to computer system 1900. The invention is directed to error identification and resolution methods and apparatus.

Computer programs (also referred to as computer control logic) are typically stored in main memory 1908 and/or secondary memory 1910. Computer programs may also be received via communications interface 1924. Such computer programs, when executed, enable the computer system 1900 to perform the features of the present invention, as discussed herein. Accordingly, such computer programs represent controllers of an individual client computer system 1900.

In an embodiment where the invention is implemented using software, the software may be stored in a computer program product and loaded into computer system 1900 using removable storage drive 1914, hard drive 1912 or communications interface 1924. The control logic (software), when executed by the processor 1904, causes the processor 1904 to perform the functions of the invention as described herein. The present error recognition and resolution method and apparatus may be downloadable to a client mobile device or personal computer from an applications store.

In another embodiment, the invention is implemented primarily in hardware using, for example, hardware components such as application specific integrated circuits (ASICs) such as the DANNA. Implementation of the hardware state machine so as to perform the functions described herein will be apparent to persons skilled in the relevant art(s) from the description above of a DANNA.

As will be apparent to one skilled in the relevant art(s) after reading the description herein, the computer architecture shown in FIG. 19 may be configured as any number of computing devices such as a system manager, a work station, a game console, a portable media player, a desktop, a laptop, a server, a tablet computer, a PDA, a mobile computer, a smart telephone, a mobile telephone, an intelligent communications device or the like.

In accordance with FIG. 20, client 2030, server 2000 and storage 2010 can be combined as a single unit (e.g., a computer or laptop), or separate units (multiple computers that communicate using, for example, a network). Each unit is able to communicate with either a user (using, for example, a keyboard, mouse, and display, not shown), a group of users of clients or a computer or device (using, for example, a wired network 2020 such as Ethernet or a wireless communications infrastructure such as IEEE 802.11 or a packet data network 2020 such as 3G cellular or PCS), which can optionally provide an interface to a user.

The server 2000 may be implemented using several networked servers with different functions allocated to each server in a cloud environment (for example, Microsoft Azure, Amazon Web Services, Google, and so on). For example, a server 2000 might be utilized for each database index. A separate server, or multiple servers, not shown, might also be utilized to process transactions and communications with clients 2030(1) and 2030(2). One or more servers 2000 might be utilized to control specialized data or image acquisition equipment such as cameras and document scanners. Alternatively, some or all of these servers might be implemented as virtual servers in one or more physical servers using software such as Xen (http://www.xen.org/), VMware ESXi (http://www.vmware.com), or Sun xVM Ops Center (http://www.sun.com/software/products/xvmopscenter/index.jsp).

As another alternative, the server 2000 could utilize a computer with multiple processors and/or multiple cores having either a symmetric multi-processing (SMP) or non-uniform memory access (NUMA) architecture. Storage 2010 can be contained within the server, or separate, as would be the case, for example, when a network-attached storage (NAS) device or storage appliance was used. Redundant storage systems may be utilized; example technologies include RAID and Sun ZFS, and may include redundant hardware, power, and network pathways. The server 2000 may, by way of example, be a Sun Fire X2200 M2 x64 Server containing two quad-core AMD model 2376 processors, 32 GB of memory, two 146 GB SAS hard disk drives, and a DVD-ROM. The bus system 2005 may include a Sun StorageTek™ 8-port external SAS PCI-Express Host Bus Adapter that is housed with the server 2000 as an interface to an external storage array 2010. The external storage array 2010 may be a Sun Storage J4200 array with 6 TB of storage. The work station systems include, for example, six Sun Ultra 24 Workstations with 22″ LCD monitors, which can be used as clients 2030 to the server 2000. Racking for the system may include an equipment rack with a power distribution unit and an uninterruptible power supply. A network switch for network 2020 is not shown but may be implied from their common utility in, for example, a local area network, a wide area local network or any telecommunications network known in the art. A typical network switch for the cloud-based server system of FIG. 20 may be the Netgear JGS524 Prosafe 24-Port Gigabit Ethernet Switch, with compatible (CAT-5e or CAT-6) cabling. If one were to use network attached storage (NAS) such as iSCSI or a network storage device such as the Sun 7200 Unified Storage System, a second network switch might be utilized to separate data traffic between the storage system 2010 and the server 2000 from data traffic between the server 2000 and other computers or clients 2030.

System components will now be discussed with reference to FIG. 21. Referring to FIG. 21, the system supporting PD, PPD, SD, SPD and image databases and resolution of errors of objects has at least one processor 2100, but may have more than one processor, and the processor may implement more than one processor core. Moreover, processor 2100 may be programmed to comprise a neuroscience-inspired dynamic architecture (FIG. 16). The system processor(s) 2100 has access to memory 2110, which is used to store index structures that enable rapid access to stored objects that have similarities to the attributes of a target object specified in a query. Storage 2120 is utilized to provide persistent memory and to serve as a repository for information that does not need to be accessed as efficiently (rapidly) as the in-memory objects. For example, images may reside in storage 2120 while descriptions of the shapes or texts of segments of these images or other attributes of the images may reside in memory 2110. One or more clients 2140 can submit queries to the server's software, which are interpreted by the processor 2100 in order to perform searches using the index structures that are resident in memory 2110 and, possibly, the data contained in the storage 2120. Results are returned by the processor 2100 to the clients 2140 via network 2130. Clients 2140 may have an outboard dynamic artificial neural network array 2145 per FIGS. 17-18. Users can interact with the system through the client(s) 2140 using input devices such as a keyboard 2142 and mouse 2144 and output devices such as a display 2146. All of the components may be implemented in a single computer system such as a laptop, desktop, or server, or they may be implemented in separate computers that interact using a communications medium such as a wired or wireless network 2130.

A data acquisition device 2150 may be connected to either a client 2140 or a server 2100, 2110, 2120 using an interface such as a serial interface, Ethernet, a data acquisition and control card, a universal serial bus (USB), or a FireWire bus or network 2130. Example data acquisition devices include near field communication devices, scanners, cameras (still image or video), antennas, infrared sensors, acoustic sensors, laser rangefinders or scanners, passive microwave sensors or related field portable devices (intelligent mobile clients) input devices. The interface 2130 to the data acquisition device 2150 may be bi-directional, meaning that the server or client can control the operation of the data acquisition device 2150 to, for example, locate and examine databases in the web that are subject to analysis such as state and local jurisdiction databases. The data acquisition device 2150 may utilize a wireless, wired, acoustic, or optical communications link to control a remote device and/or acquire information from a remote device.

Large Telecommunications Service Provider Examples

What follows are three or more different examples of application of the present invention for negotiating with a large telecommunications service provide (or other public utility). Telecommunications service providers seem to frequently offer ways for consumers to save money on their bills. In one example, a family of four, each having their own mobile phone, may receive telecommunications service for $160 per month as a family. This new family plan may be advertised on an invoice and so attract the invoice recipient to investigate the newly offered family plan. This telecommunications service provider may be in heated competition with a second telecommunications service provider. Currently, by way of example, a given user's mobile phone service monthly bill is $240 per month for service from the first service provider. According to the present invention, as shown in FIG. 2, a user's client device scans the current $240 per month invoice and identifies individual services and fees for those services. Using artificial intelligence, the client device 230 parses the invoice into individual services and fees and refers its summary of the features and charges to a search manager 220. It assigns manager 220 a task to identify family plans offered by the first telecommunications service provider including the one the family is currently using and the one advertised on the invoice as well as those of similarly situated other telecommunications service providers to determine which telecommunications service providers compare and how in terms of quality of service and comparable prices for family plan features. Thus manager 220 may serve as a cloud investigator to investigate products and services currently subscribed to and those of potential interest to a variety of clients 230. To do so, the search manager 220 may refer to the off the shelf database 200 which periodically collects information from service providers or uses a search engine 210 to collect feature, quality and price data for repository at the database 200. In this first example, let us assume that a second telecommunications service provider is evaluated at equivalent quality of service for $180 per month for a family of four. Therefore, it may be appropriate for client 230 to negotiate on-line to accept the advertised offer of $160 per month for a family plan for four persons from the first telecommunications service provider (or not).

There are a number of ways to negotiate automatically with a provider of products and services besides near field communication. One is an automated chat line. A chat line is known which requests an on-line query and will search and output a response. For example, what is the monthly service fee for a family of four mobile phones? The chat line may not accept such a question and respond that the query should be simpler and more direct. Such a chat line may have a plurality of levels of query reaching more sophisticated chat software or finally connect a client 230 to a live person. The live person may understand the question and the client 230 successfully negotiate with the live person or be refused (because the live person will recognize that the chatter is not a live person but a machine). Nevertheless, it is possible with ever-improving automated chat lines that one artificially intelligent chat machine may successfully communicate with and negotiate a favorable deal meeting user established criteria for mobile telephone service for a family of four with one or another product or service provider.

On the other hand, it may be assumed that client 230 may likewise enter into negotiations with the second telecommunications service provider at $180 per month and successfully obtain a “switch” offer at $140 per month for a family of four. It is likewise known that it costs a telecommunications carrier revenues and expenses if a subscriber “switches” their telecommunications carrier and may offer better deals than advertised deals. If the further $20 savings is worth it, a user, via the client 230, may find the “switch” offer attractive but may need to check for hidden contract fees and the like with the first service provider. For example, equipment return charges may apply if the mobile phones have not been under contract for certain predetermined periods of time.

In one instance, a return may be required by packing, for example, a cable television set top box with an internet modem and return them together to a central facility of the first telecommunications service provider. This telecommunications service provider may not recognize the return of the expensive set top box (but recognize the return of the less expensive modem). On one's next service invoice, it may be determined by client 230 that one of the charges is for a new cable television set top box notwithstanding its return to the service provider. In such an instance, again, the present client 230 may have to open negotiations with the telecommunications service provider to have the set top box located in the central facility and have the charge removed from the bill.

A further example is that at least one telecommunications service provider may bill customers for unauthorized charges and services that the provider itself does not offer. For example, an instance has been known where a charge for Internet Xpress has appeared on an invoice and when the charge was challenged on the invoice through a client device 230, the carrier did not recognize Internet Xpress as a service they provide and allowed a credit for Internet Xpress to the challenging client 230. Unauthorized third-party charges, commonly referred to as mobile cramming, have been the subject of FCC investigations leading to several large service providers paying multi-million dollar settlements to refund customers. (See https://www.fcc.gov/guides/cramming-unauthorized-misleading-or-deceptive-charges-placed-your-telephone-bill.) While consumers may unknowingly pay for unauthorized charges, client 230 may automatically detect unauthorized charges as they occur and automatically negotiate with the service provider to resolve the error in a timely manner. In contrast, requesting a refund through these settlements may only cover a specific type of billing discrepancy and take months to process. A client 230 may also use the search manager 220 and search engines 210 to periodically check for available refunds and settlements that apply to goods or services purchased by the user.

Another example is when credit is given by at least one known telecommunications carrier, that telecommunications carrier grants an initial credit and then, several months later, may rebill for the credit as services not previously paid for. Again, client 230 may be called upon to negotiate with the carrier to remove the charges, previously credited, as new charges. Client 230 may automatically scan and test the customer's bills on a recurring basis to ensure that previously-resolved unauthorized charges are not repeated in subsequent bills.

A further example is requesting the telecommunications carrier to change one's address through an automated chat line. For example, a profile stored in client 230 may indicate that the user of the device lives in Apartment 2710. Yet, the invoice, scanned into client device 230 shows that the telecommunications carrier is sending materials to Apartment 271 with the 0 of 2710 on a separate line. This can be of obvious concern if invoices are sent to the wrong apartment number and never reach apartment 2710. Late fees for incorrect data entry may be applied. The client 230 may originate a chat line request, for example, automatically after a lapsed period of time of, for example, one month if no invoice is received or from scanning an invoice showing an incorrect apartment number.

The client 230 may form a simple query to the automated chat line, Will you help me change my billing address? As suggested, the automated chat line may desire a more simple query or may be sophisticated enough to respond. For example, the chat line may ask in sequence: what is your account number, what is the billing address we are currently using for this account and what is the new correct billing address for this account to which client 230 may provide the correct information. By way of feedback to the client 230, the chat line may confirm: We have corrected the billing address for account XXXX to read Apartment 2710.

A further embodiment of the present invention may aggregate data from billing discrepancies detected by the system and automatically detect patterns in overbilling. This feature may be used, for example, to correlate instances of billing errors with customer demographic data to detect whether certain groups are being disproportionately targeted by deceptive billing practices. Such data may be used to inform consumers of potential claims, complaints or class action lawsuits against service providers that are found to repeatedly overbill its customers. Error detection and resolution history may be stored on the COTS database 200 and shared with users to provide evidence for a potential claim when the same type of billing error affects a large number of users. A further application of this embodiment may be to detect any billing the government for unauthorized or inflated charges, and provide a basis for a qui tam claim against service providers who overbill the government.

Automobile Purchase Example

Another example of the present invention's utility may be to automatically analyze an invoice for an automobile and use the search engine to detect any suspicious charges on the invoice and to compare the price with other similar automobiles available for purchase. Invoices may be obtained by scanning or otherwise inputting a document, or by obtaining data from a NFC terminal The invention may search the web per FIG. 2 to find pricing information in the Kelley Blue Book and also through a web search for other dealerships or individuals selling vehicles in similar condition with comparable mileage and features. For used vehicles, several websites list and compare available prices. The invention may combine and analyze data obtained through a web search to provide a negotiating tool for the consumer. In one embodiment, the invention may obtain the amount paid by dealers on the original invoice and compare this with the MSRP as well as the dealer's asking price. The invention may allow customers to base a purchase price on the original invoice and select how much commission they are willing to pay the dealer.

All United States and foreign patents and articles whose citations are provided above should be deemed to be incorporated by reference as to their entire contents for the purposes of understanding the underlying technology behind an embodiment of a method and apparatus for predicting object properties using similarity-based information retrieval and modeling. The embodiments of a method and apparatus for document error recognition and resolution using similarity-based information retrieval and modeling described above should only be deemed to be limited by the scope of the claims which follow.

What we claim is:

1. A method of detecting a tax application error in a document and automatically resolving the error, the method performed on a special purpose client/server computer system comprising a neuroscience-inspired dynamic architecture and a dynamic neural network array of selectable neurons and synapses programmed to perform the method comprising:
inputting a document into the system by at least one of scanning, near field communication or camera and by recording product and service objects from the document in one of a product and service transaction database, the object comprising at least one suspicious transaction in the transaction database, the transaction database being coupled to processor search manager apparatus, the processor search manager apparatus comprising a processor and memory, the client connected to the dynamic neural network array and a processor comprising the neuro-science inspired dynamic architecture coupled to the transaction database,
testing by said processor of hypotheses of correctness of the document by parsing the documents into component attributes and defining a vector space of attributes for the product or service database, said product or service transaction database comprising one of a similarity-based and a nearest neighbor search to identify the document error as a tax application error and consulting a server and related database located in the internet cloud for collecting data for determining the likelihood of the error;
applying at least one model to results returned from the database in response to a tax query, the tax query requesting objects in said transaction database most similar to a target object, the queried objects, responsive to the query, being most similar to each other, the testing including testing at least the document tax application error hypothesis and resolving the error by engaging in communication with a product or service provider setting forth the identification of the error, the basis of the error and a proposed resolution of the document error by near field communication with a transaction terminal.

2. The method of claim 1, the transaction database comprising purchasing patterns of a plurality of consumers, the method further comprising applying the model to consumer members of a cluster of similar consumer behavior to obtain a relationship comprising a flow of one of capital, goods and services between consumer members of the cluster.

3. The method of claim 1 an organizational structure hypothesis comprising interactions among a plurality of communication devices forming nodes of a communications network.

4. The method of claim 1 wherein the transaction comprises a medical record of medical data of a medical claim of a consumer of medical services to detect a pattern of fraudulent activity of a medical service provider.

5. The method of claim 1, the transaction database comprising a financial transaction database, the method comprising predicting an instance of consumer fraud by one of a product provider and a service provider responsive to a query of the financial transaction database of one of the client and the server.

6. The method of claim 1 further comprising mining transaction information stored in the transaction database to identify a cluster representing a similar behavior including a purchasing pattern of one of a consumer and an enterprise.

7. The method of claim 1 further comprising a plurality of databases, the plurality of databases including a product database, a product provider database, a service database, a service provider database and an image database, the method further comprising identification of a different product or service provider if resolution of a product or service document error does not occur.
